(19) United States
(12) Patent Application Publication
(10) Pub. No.: US 2020/0091560 A1
(43) Pub. Date: Mar. 19, 2020

(54) BATTERY, BATTERY PACK, AND VEHICLE

(71) Applicants: KABUSHIKI KAISHA TOSHIBA, Minato-ku (JP); Toshiba Infrastructure Systems & Solutions Corporation, Kawasaki-shi (JP)

(72) Inventors: Tetsuya Sasakawa, Yokohama (JP); Kazuomi Yoshima, Yokohama (JP); Norio Takami, Yokohama (JP)

(73) Assignees: KABUSHIKI KAISHA TOSHIBA, Minato-ku (JP); Toshiba Infrastructure Systems & Solutions Corporation, Kawasaki-shi (JP)

(21) Appl. No.: 16/288,312

(22) Filed: Feb. 28, 2019

(30) Foreign Application Priority Data
Sep. 13, 2018 (JP) 2018-171769

(51) Int. Cl. H01M 10/0585; H01M 2/10; H01M 4/48; H01M 4/66; H01M 10/054; H01M 10/0525

(52) U.S. Cl. CPC H01M 10/0585; H01M 2/1077; H01M 4/48; H01M 2220/20; H01M 10/054; H01M 10/0525; H01M 4/661

(57) ABSTRACT

According to one embodiment, a battery includes a container member, electrode groups, and a sheet member. In the interior of the container member, the sheet member forms a partition wall that separates adjacent electrode groups from each other. The sheet member includes a metal layer and an insulating layer. In the sheet member, the metal layer forms an electric path, and the electric path electrically connects the adjacent electrode groups. In the sheet member, the insulating layer is laminated on both sides of the metal layer in an arranging direction of the adjacent electrode groups.

### CROSS-REFERENCE TO RELATED APPLICATION

This application is based upon and claims the benefit of priority from Japanese Patent Application No. 2018-171769, filed Sep. 13, 2018, the entire contents of which is incorporated herein by reference.

### FIELD

Embodiments relate to a battery, a battery pack, and a vehicle.

### BACKGROUND

Recently, batteries such as lithium ion batteries are variously applied. For example, batteries are installed on vehicles. Therefore, there is a demand for further higher capacity, longer life, and higher output of batteries. For example, in a battery using a lithium titanium-containing oxide as a negative electrode active material of an electrode group, the volume change of the lithium titanium-containing oxide corresponding to charge and discharge is small, and thus the cycle characteristic is excellent. In addition, in principle, it is difficult for a lithium metal to precipitate in the lithium insertion-extraction reaction of the lithium titanium-containing oxide. Therefore, in the battery using the lithium titanium-containing oxide as the negative electrode active material of the electrode group, performance deterioration is small even when charge and discharge are repeated with a large current.

On the other hand, in the battery such as the lithium ion battery, even if the electrode group is increased in size, a voltage obtained from a unit battery including only one electrode group is about 2.3 V or more and 3.7 V or less. Therefore, in order to obtain a high voltage, it is necessary to electrically connect a plurality of unit batteries. In order to provide a plurality of unit batteries and control each of the unit batteries, an entire device such as a battery pack including the unit batteries is increased in size.

For example, in a battery, a high voltage can be obtained by electrically connecting a plurality of electrode groups in series in a container member, without increasing the size of the entire device. However, in the configuration in which the electrode groups are housed in the container member, there is a possibility that the electrode groups will be short-circuited via an electrolytic solution and the electrode groups will be short-circuited due to ionic conduction.

There is also a battery in which a gel electrolyte instead of the electrolytic solution is used as a nonaqueous electrolyte. Examples of the gel electrolyte include a semi-solidified product made by impregnating a polymer such as polyethylene oxide (PEO) and polyvinylidene fluoride (PVdF) with an electrolytic solution. In addition, since the ion conductivity of the gel electrolyte is high to a certain extent, sufficient output density can be obtained even in the battery using the gel electrolyte. However, the gel electrolyte is easy to soften. For this reason, in the configuration in which the electrode groups are housed in the container member, there is a possibility that the electrode groups will be short-circuited via a softened gel electrolyte and the electrode groups will be short-circuited due to ionic conduction.

### BRIEF DESCRIPTION OF THE DRAWINGS

FIG. 1 is a schematic view showing a battery according to a first embodiment;

FIG. 2 is a cross-sectional view schematically showing an A1-A1 cross section of FIG. 1;

FIG. 3 is a schematic view showing an example of a configuration of each of a plurality of electrode groups in the battery according to the first embodiment;

FIG. 4 is a schematic view showing a configuration of a sheet member in the battery according to the first embodiment;

FIG. 5 is a cross-sectional view schematically showing an A2-A2 cross section of FIG. 2;

FIG. 6 is a cross-sectional view schematically showing an A3-A3 cross section of FIG. 2;

FIG. 7 is a cross-sectional view schematically showing a battery according to a first modification of the first embodiment;

FIG. 8 is a cross-sectional view schematically showing a battery according to a second modification of the first embodiment;

FIG. 9 is a cross-sectional view schematically showing a sheet member of a battery according to a third modification of the first embodiment;

FIG. 10 is a cross-sectional view schematically showing a sheet member of a battery according to a fourth modification of the first embodiment;

FIG. 11 is an exploded perspective view schematically showing an example of a battery pack using the battery according to an embodiment;

FIG. 12 is a schematic view showing a circuit configuration of the battery pack of FIG. 11;

FIG. 13 is a schematic view showing an example of a vehicle, on which the battery pack using the battery is installed, according to an embodiment; and

FIG. 14 is a schematic view showing an example of a control system related to an electrical system in the vehicle, on which the battery pack using the battery is installed, according to an embodiment.

### DETAILED DESCRIPTION

According to one embodiment, a battery includes a container member, electrode groups, and at least one sheet member. The electrode groups are housed inside the container member, and each of the electrode groups includes a positive electrode and a negative electrode. In the interior of the container member, the at least one sheet member forms a partition wall that separates adjacent electrode groups, which are adjacent to each other. The at least one sheet member includes a metal layer and an insulating layer. In the sheet member, the metal layer forms an electric path, and the electric path electrically connects the adjacent electrode groups. In the sheet member, the insulating layer is made of a material having electrical insulation properties and is laminated on both sides of the metal layer in the arranging direction of the adjacent electrode groups.

In addition, according to the embodiment, a battery pack including one or more above-described batteries is provided.

Furthermore, according to the embodiment, a vehicle including the above-described battery pack is provided.

Hereinafter, embodiments will be described with reference to the drawings.

[Battery]

First, a battery according to an embodiment will be described.

### First Embodiment

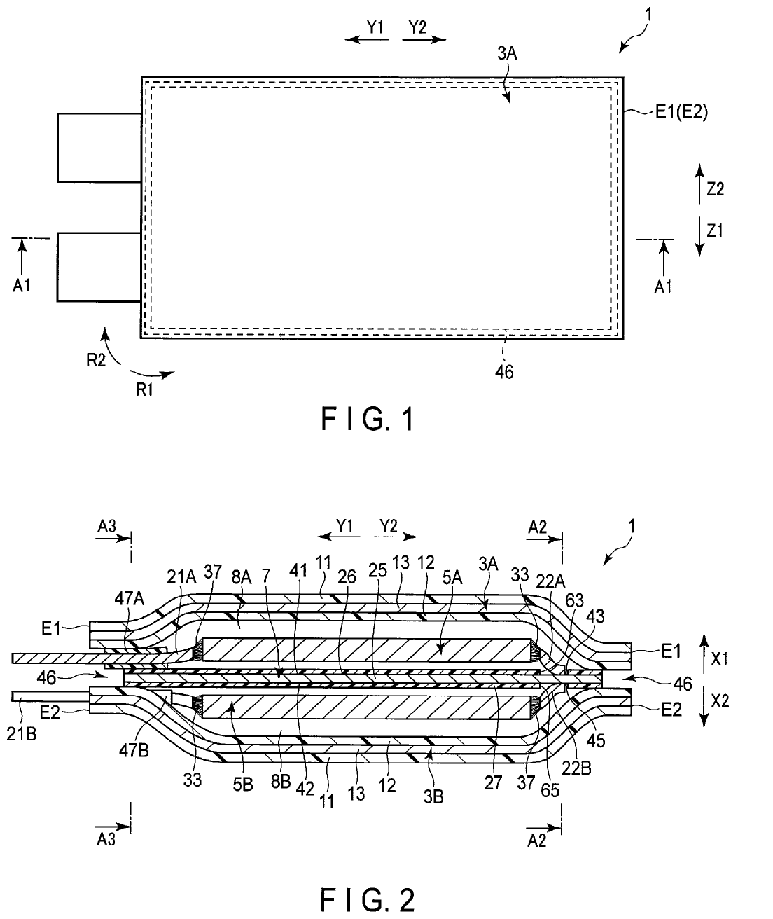

FIGS. 1 and 2 show a battery 1 of a first embodiment as an example of a battery. The battery 1 is, for example, a secondary battery. FIG. 2 is an A1-A1 cross section of FIG. 1. As shown in FIGS. 1 and 2 and the like, the battery 1 of the present embodiment includes container members 3A and 3B, plural (two in the present embodiment) electrode groups 5A and 5B, a sheet member 7, an electrolyte (not shown). The container members 3A and 3B form the exterior of the battery 1. The electrode groups 5A and 5B, the sheet member 7, and the electrolyte are housed inside the container members 3A and 3B. The electrolyte is held (impregnated) in each of the electrode groups 5A and 5B. The battery 1 is formed by sealing a space between the container members 3A and 3B in a state in which the electrode groups 5A and 5B, the sheet member 7, and the electrolyte are housed inside the container members 3A and 3B.

In the present embodiment, each of the container members 3A and 3B is made of a laminated film including two resin layers 11 and 12 and a metal layer (film metal layer) 13 interposed between the resin layers 11 and 12. The resin layers 11 and 12 of the laminated film are made of a resin having electrical insulation properties and thermal adhesiveness. In each of the container members 3A and 3B made of the laminated film, the outer surface is made of the resin layer (first resin layer) 11, and the inner surface is made of the resin layer (second resin layer) 12. Therefore, in each of the container members 3A and 3B, the metal layer 13 is not exposed.

The electrode groups 5A and 5B are arranged inside the container members 3A and 3B. Therefore, in the battery 1 of the present embodiment, the arranging direction of the electrode groups 5A and 5B (direction indicated by arrows X1 and X2) is defined. In addition, in the battery 1, a first direction (direction indicated by an arrow Y1 and an arrow Y2) intersecting with the arranging direction and a second direction (direction indicated by an arrow Z1 and an arrow Z2) intersecting with both the arranging direction and the first direction are defined. The first direction is, for example, a direction perpendicular to or substantially perpendicular to the arranging direction, and the second direction is, for example, a direction perpendicular to or substantially perpendicular to both the arranging direction and the first direction. Note that FIG. 1 shows a state viewed from one side in the arranging direction, and FIG. 2 shows a cross section perpendicular to or substantially perpendicular to the second direction. In addition, in the battery 1, a circumferential direction (direction indicated by an arrow R1 and an arrow R2) along the outer edges (E1, E2) of the container members 3A and 3B is defined.

The sheet member 7 is disposed between the electrode groups 5A and 5B in the arranging direction of the electrode groups 5A and 5B. Inside the container members 3A and 3B, the sheet member 7 isolates the electrode groups 5A and 5B arranged adjacent to each other. Therefore, the sheet member 7 serves as a partition wall for isolating the electrode groups 5A and 5B, and the two electrode groups 5A and 5B that are adjacent to each other are objects to be isolated by the sheet member 7. With the configuration as described above, the sheet member 7 separates the interior of the container members 3A and 3B into a space 8A in which the electrode group 5A is arranged and a space 8B in which the electrode group 5B is arranged. Note that the electrolyte is held in the electrode group 5A in the space 8A and held in the electrode group 5B in the space 8B.

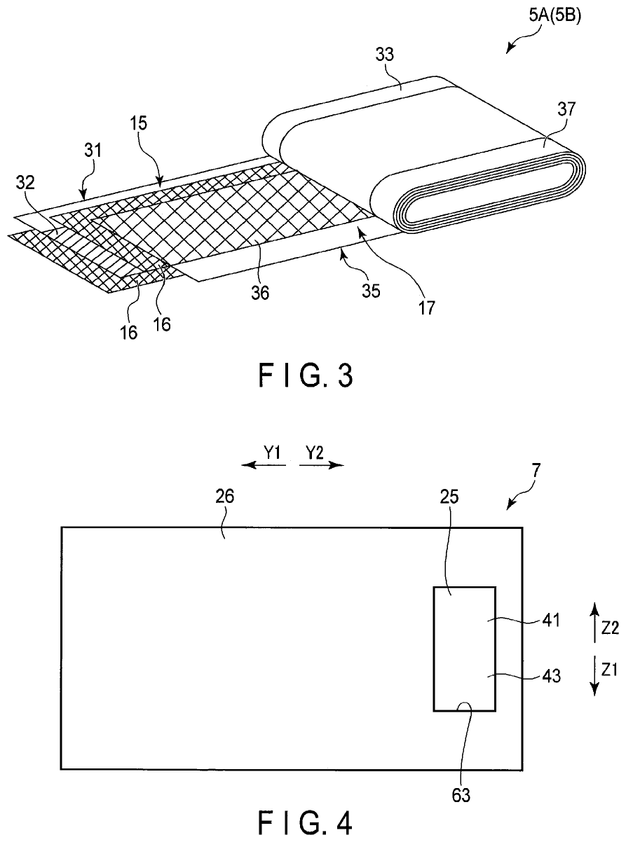

FIG. 3 is a view showing an example of the configuration of each of the electrode groups 5A and 5B. As shown in FIG. 3 and the like, each of the electrode groups 5A and 5B includes a negative electrode 15, a separator 16, and a positive electrode 17. The separator 16 is interposed between the negative electrode 15 and the positive electrode 17, and electrically insulates the negative electrode 15 from the positive electrode 17. In the example of FIG. 3, each of the electrode groups 5A and 5B has a structure spirally wound in a state in which the separator 16 is interposed between the positive electrode 17 and the negative electrode 15, and is formed in, for example, a flat shape. In addition, in another example, in each of the electrode groups 5A and 5B, the negative electrode 15, the positive electrode 17, and the separator 16 are formed in a flat plate shape. Each of the electrode groups 5A and 5B has a structure in which the positive electrode 17, the separator 16, the negative electrode 15, and the separator 16 are laminated in this order.

The negative electrode 15 includes a negative electrode current collector 31 and a negative electrode mixture layer 32. The negative electrode mixture layer 32 is supported on both sides or one side of the negative electrode current collector 31. Similarly, the positive electrode 17 includes a positive electrode current collector 35 and a positive electrode mixture layer 36. The positive electrode mixture layer 36 is supported on both sides or one side of the positive electrode current collector 35. In addition, the negative electrode current collector 31 includes a negative electrode current collecting tab 33 that is a non-supported portion of the negative electrode mixture layer 32. Similarly, the positive electrode current collector 35 includes a positive electrode current collecting tab 37 that is a non-supported portion of the positive electrode mixture layer 36. In the present embodiment, in each of the electrode groups 5A and 5B, the negative electrode current collecting tab 33 protrudes with respect to the positive electrode 17 and the separator 16. In each of the electrode groups 5A and 5B, the positive electrode current collecting tab 37 protrudes with respect to the negative electrode 15 and the separator 16 toward the side opposite to the side toward which the negative electrode current collecting tab 33 protrudes.

As shown in FIG. 2 and the like, the battery 1 includes leads 21A, 21B, 22A, and 22B. In the present embodiment, the leads 21A and 22A are connected to the electrode group 5A, and the leads 21B and 22B are connected to the electrode group 5B. In the present embodiment, in the electrode group 5A, the lead 21A is connected to the positive electrode current collecting tab 37, and the lead 22A is connected to the negative electrode current collecting tab 33. In the electrode group 5B, the lead 21B is connected to the negative electrode current collecting tab 33, and the lead 22B is connected to the positive electrode current collecting tab 37. The leads 21A and 21B protrude to the outside of the container members 3A and 3B. In the present embodiment, the lead 21A extends outward from the space 8A, and the lead 21B extends outward from the space 8B. In addition, in the battery 1, the protrusion portions to the outside of the container members 3A and 3B in the leads 21A and 21B serve as electrode terminals. In the present embodiment, the protrusion portion to the outside in the lead 21A serves as a positive electrode terminal of the battery 1, and the protrusion portion to the outside in the lead 21B serves as a negative electrode terminal of the battery 1.

In the present embodiment, the lead 21B is positioned on the side on which the lead 21A is positioned with respect to the electrode groups 5A and 5B in the first direction. The leads 21A and 21B are arranged apart from each other in the second direction. In addition, the leads 22A and 22B are positioned on the side opposite to the side on which the leads 21A and 21B are positioned with respect to the electrode groups 5A and 5B in the first direction. Note that FIG. 2 shows a cross section passing through the lead 21A and passing through the leads 22A and 22B.

The sheet member 7 is made of a laminated sheet including a metal layer 25 and two insulating layers 26 and 27. In the sheet member 7, the metal layer 25 is interposed between the insulating layers 26 and 27. The metal layer 25 is made of a metal having conductivity. In addition, the insulating layers 26 and 27 are made of a resin having electrical insulation properties and thermal adhesiveness, and are preferably made of the same material as the resin layer (second resin layer) 12 of the container members 3A and 3B. The metal layer 25 has a surface (first surface) 41 facing one side in the arranging direction of the electrode groups 5A and 5B, that is, a side on which the electrode group 5A is positioned. In addition, the metal layer 25 has a surface (second surface) 42 facing the side opposite to a side toward which the surface 41 faces in the arranging direction of the electrode groups 5A and 5B, that is, a side on which the electrode group 5B is positioned. In the sheet member 7, an insulating layer (first insulating layer) 26 is laminated on the surface 41 of the metal layer 25, and an insulating layer (second insulating layer) 27 is laminated on the surface 42 of the metal layer 25. Since the insulating layers 26 and 27 are laminated as described above, the insulating layers (26, 27) are laminated on both sides of the metal layer 25 in the arranging direction of the electrode groups 5A and 5B in the sheet member 7.

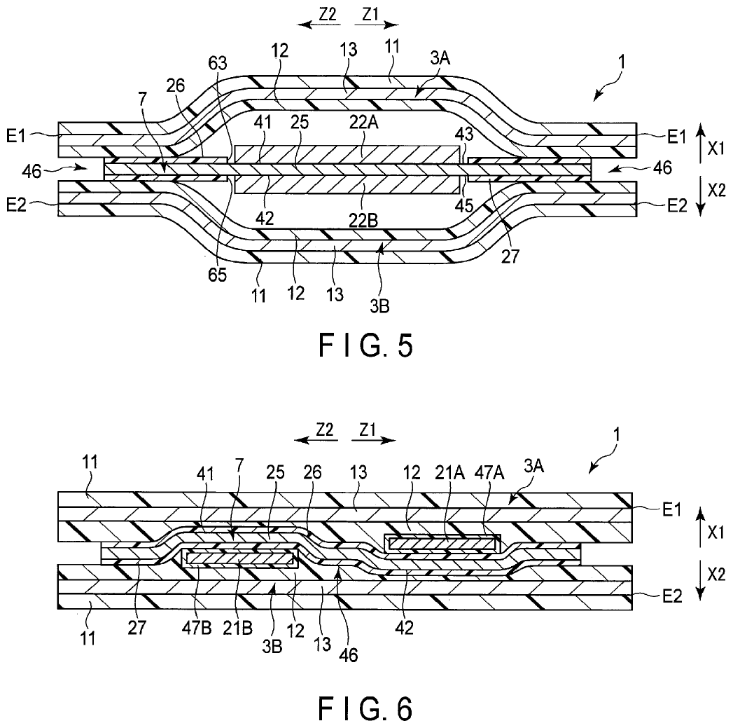

FIG. 4 shows the configuration of the sheet member 7, and FIG. 5 shows an A2-A2 cross section of FIG. 2. FIG. 4 shows a state in which the sheet member 7 is viewed from the side toward which the surface (first surface) 41 of the metal layer 25 faces. As shown in FIGS. 2, 4, and 5, and the like, in the sheet member 7, an opening hole (first opening hole) 43 is formed in the insulating layer 26 and an opening hole (second opening hole) 45 is formed in the insulating layer 27. In the opening hole 43, the insulating layer 26 is not laminated on the surface 41 of the metal layer 25, and the surface 41 of the metal layer 25 is exposed. In addition, in the opening hole 45, the insulating layer 27 is not laminated on the surface 42 of the metal layer 25, and the surface 42 of the metal layer 25 is exposed. The insulating layer 26 has an edge surface (first edge surface) 63 surrounding the opening hole 43, and the insulating layer 27 has an edge surface (second edge surface) 65 surrounding the opening hole 45. The edge surface (opening edge surface) 63 is the peripheral surface of the opening hole 43, and the edge surface (opening edge surface) 65 is the peripheral surface of the opening hole 45. Note that FIG. 5 shows a cross section passing through the opening holes 43 and 45 and perpendicular to or substantially perpendicular to the first direction.

In the present embodiment, the opening holes 43 and 45 are formed on the side on which the leads 22A and 22B are positioned with respect to the electrode groups 5A and 5B in the first direction. Therefore, the opening hole 45 is positioned on the side on which the opening hole 43 is positioned with respect to the electrode groups 5A and 5B in the first direction. In addition, the insulating layer (first insulating layer) 26 is laminated over all or substantially all the regions excluding the opening hole (first opening hole) 43 in the surface (first surface) 41 of the metal layer 25. The insulating layer (second insulating layer) 27 is laminated over all or substantially all the regions excluding the opening hole (second opening hole) 45 in the surface (second surface) 42 of the metal layer 25.

In the battery 1, in the opening hole 43, the lead 22A is connected to the metal layer 25. Therefore, the electrode group 5A, which is one of the electrode groups 5A and 5B to be isolated by the sheet member 7, is electrically connected to the metal layer 25 through the opening hole (first opening hole) 43. In addition, in the battery 1, in the opening hole 45, the lead 22B is connected to the metal layer 25. Therefore, the electrode group 5B, which is the other of the electrode groups 5A and 5B to be isolated by the sheet member 7, is electrically connected to the metal layer 25 through the opening hole (second opening hole) 45. Therefore, the leads 22A and 22B and the metal layer 25 of the sheet member 7 form an electric path which electrically connects the electrode groups 5A and 5B. In the present embodiment, since the electrode groups 5A and 5B are connected to the metal layer 25 as described above, the electrode groups 5A and 5B are electrically connected in series to each other.

FIG. 6 shows an A3-A3 cross section of FIG. 2. As shown in FIGS. 1, 2, 5, and 6, and the like, a sealing portion 46 which seals the container members 3A and 3B is provided in the battery 1. The sealing portion 46 is continuously formed over the entire circumference in the circumferential direction of the battery 1. Therefore, the interior of the container members 3A and 3B are airtightly sealed to the outside by the sealing portion 46. In the sealing portion 46, the insulating layer (first insulating layer) 26 of the sheet member 7 is directly fused to the resin layer 12 of the container member 3A (the inner surface of the container member 3A), except for the portion in which the leads 21A and 21B extend to the outside. In addition, in the sealing portion 46, the insulating layer (second insulating layer) 27 of the sheet member 7 is directly fused to the resin layer 12 of the container member 3B (the inner surface of the container member 3B), except for the portion in which the leads 21A and 21B extend to the outside. Note that FIG. 6 shows a cross section passing through the leads 21A and 21B and the sealing portion 46 and perpendicular to or substantially perpendicular to the first direction.

In addition, a band 47A is attached to the outer surface of the lead 21A in a state of being wound, and a band 47B is attached to the outer surface of the lead 21B in a state of being wound. Each of the bands 47A and 47B is made of a resin having electrical insulation properties and thermal adhesiveness, and is preferably made of the same material as the resin layers 12 of the container members 3A and 3B and the insulating layers 26 and 27 of the sheet member 7.

In the portion in which the lead 21A extends to the outside in the sealing portion 46, the sheet member 7 is interposed between the lead 21A and the container member 3B. Therefore, in the portion in which the lead 21A extends to the outside in the sealing portion 46, the insulating layer (first insulating layer) 26 of the sheet member 7 is fused to the resin layer 12 of the container member 3A (the inner surface of the container member 3A) via the band 47A of the lead 21A, and the insulating layer (second insulating layer) 27 of the sheet member 7 is directly fused to the resin layer 12 of the container member 3B (the inner surface of the container member 3B). In addition, in the portion in which the lead 21B extends to the outside in the sealing portion 46, the sheet member 7 is interposed between the lead 21B and the container member 3A. Therefore, in the portion in which the lead 21B extends to the outside in the sealing portion 46, the insulating layer (first insulating layer) 26 of the sheet member 7 is directly fused to the resin layer 12 of the container member 3A (the inner surface of the container member 3A), and the insulating layer (second insulating layer) 27 of the sheet member 7 is fused to the resin layer 12 of the container member 3B (the inner surface of the container member 3B) via the band 47B of the lead 21B.

As described above, since the insulating layers (26, 27) of the sheet member 7 are fused to the resin layers 12 of the container members (3A, 3B), the sheet member 7 is firmly attached to the container members 3A and 3B, and the electrode groups 5A and 5B are appropriately isolated in the interior of the container members 3A and 3B. In addition, the electrical insulation of the metal layer 25 of the sheet member 7 with respect to the leads 21A and 21B is properly secured by providing the insulating layers 26 and 27 of the sheet member 7 and the bands 47A and 47B. Note that, in the lead 21A, the band 47A is attached only to the portion forming the sealing portion 46 and the vicinity thereof, and the portion apart from the portion forming the sealing portion 46 is not covered with the band 47A. Similarly, in the lead 21B, the band 47B is attached only to the portion forming the sealing portion 46 and the vicinity thereof, and the portion apart from the portion forming the sealing portion 46 is not covered with the band 47B.

In the present embodiment, the electrode groups 5A and 5B are isolated from each other by providing the sheet member 7. The electrode group 5A is electrically connected to the metal layer 25 of the sheet member 7 only in the opening hole 43, and the electrode group 5B is electrically connected to the metal layer 25 of the sheet member 7 only in the opening hole 45. In addition, by providing the insulating layer 26, it is possible to effectively prevent short circuit between the electrode group 5A and the surface 41 of the metal layer 25 via the electrolyte such as the electrolytic solution and the gel electrolyte in the portions other than the opening hole 43. That is, the short circuit between the electrode group 5A and the metal layer due to ionic conduction is effectively prevented. Similarly, by providing the insulating layer 27, it is possible to effectively prevent short circuit between the electrode group 5B and the surface 42 of the metal layer 25 via the electrolyte in the portions other than the opening hole 45. That is, the short circuit between the electrode group 5B and the metal layer 25 due to ionic conduction is effectively prevented.

With the configuration as described above, in the battery 1 of the present embodiment, even when the electrode groups 5A and 5B are provided inside the container members 3A and 3B, short circuit between the electrode groups 5A and 5B via the electrolyte is effectively prevented. That is, in the present embodiment, the battery 1 is provided which can effectively prevent short circuit due to ionic conduction between the electrode groups 5A and 5B in the configuration in which the electrode groups 5A and 5B are provided inside the container members 3A and 3B.

(Modification of First Embodiment)

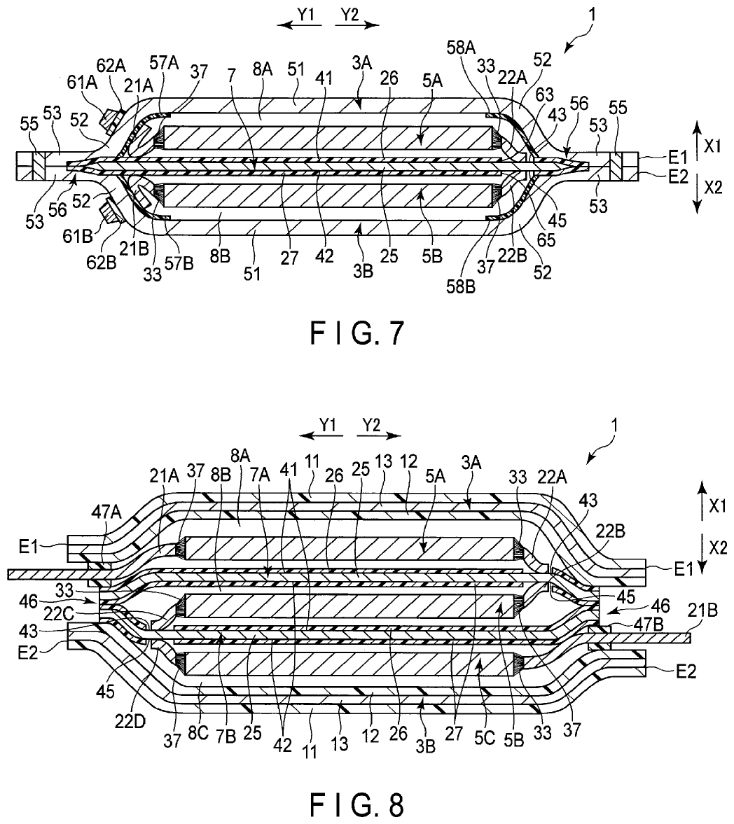

FIG. 7 shows a battery 1 according to a first modification of the first embodiment. In the present modification, each of container members 3A and 3B is a container that is not made of a laminated film, but is made of a metal such as stainless steel. In the present modification, each of the container members 3A and 3B includes a bottom wall 51 and a side wall 52. Each of the container members 3A and 3B has a flange 53 protruding outward from an end portion of the side wall 52 on the side opposite to the side on which the bottom wall 51 is positioned. In each of the container members 3A and 3B, the flange 53 is continuously formed over the entire circumference in the circumferential direction of the battery 1. In each of the container members 3A and 3B, an outer edge (E1; E2) is formed by the flange 53.

In the battery 1 of the present modification, the container members 3A and 3B are arranged in a state in which the flanges 53 of them face each other. A welding portion 55, in which the flanges 53 of the container members 3A and 3B are welded, is formed in the battery 1. The welding portion 55 is formed by, for example, resistance seam welding. The welding portion 55 is continuously formed over the entire circumference in the circumferential direction of the battery 1. Therefore, in the present modification, a space between the container members 3A and 3B is sealed by the welding portion 55, and the interior of the container members 3A and 3B is airtightly sealed to the outside.

In addition, in the battery 1 of the present modification, a caulking portion 56 is formed on the inner side (the side close to the electrode groups 5 A and 5B) with respect to the welding portion 55. In the present embodiment, the caulking portion 56 is continuously formed over the entire circumference in the circumferential direction of the battery 1. The caulking portion 56 is formed by caulking the container members 3A and 3B and the sheet member 7 in a state in which the sheet member 7 is disposed between the flanges 53 of the container members 3A and 3B. By forming the caulking portion 56 as described above, the sheet member 7 is firmly attached to the container members 3A and 3B, and the electrode groups 5A and 5B are appropriately isolated in the interior of the container members 3A and 3B. In the present modification as well, insulating layers 26 and 27 are provided in the sheet member 7. In the caulking portion 56, the insulating layers 26 and 27 prevent the metal layers 25 of the sheet members from coming into contact with the container members 3A and 3B. Therefore, in the present modification, the metal layers 25 of the sheet member 7 are electrically insulated from the container members 3A and 3B.

In the present modification as well, leads 21A, 21B, 22A, and 22B are provided similarly to the above-described embodiment and the like. However, in the present modification, the leads 21A and 21B do not extend to the outside of the container members 3A and 3B. In addition, in the present modification, the lead 21A is electrically insulated from the container member 3A by the insulating member 57A or the like disposed on the inner surface of the container member 3A. The lead 21B is electrically insulated from the container member 3B by the insulating member 57B or the like disposed on the inner surface of the container member 3B. In addition, the lead 22A is electrically insulated from the container member 3A by the insulating member 58A or the like disposed on the inner surface of the container member 3A. The lead 22B is electrically insulated from the container member 3B by the insulating member 57B or the like disposed on the inner surface of the container member 3B.

In the present modification, the electrode group 5A is electrically connected to the metal layer 25 of the sheet member 7 only in the opening hole 43, and the electrode group 5B is electrically connected to the metal layer 25 of the sheet member 7 only in the opening hole 45. In the present modification as well, the insulating layer 26 effectively prevents short circuit between the electrode group 5A and the surface 41 of the metal layer 25 via the electrolyte in portions other than the opening hole 43. Similarly, the insulating layer 27 effectively prevents short circuit between the electrode group 5B and the surface 42 of the metal layer 25 via the electrolyte in portions other than the opening hole 45.

In addition, in the present modification, insulating bands (not shown) and the like are wound around the electrode groups 5A and 5B, respectively, and the above-described insulating members 57A, 57B, and 58A, 58B are provided in the battery 1. Therefore, the contact of the electrode group 5A with the container member 3A and the contact of the electrode group 5B with the container member 3B are effectively prevented. In addition, the electrical connection of the electrode group 5A to the container member 3A via the electrolyte or the like is effectively prevented, and the electrical connection of the electrode group 5B to the container member 3B via the electrolyte or the like is effectively prevented.

In addition, in the present modification, an electrode terminal 61A is attached to the outer surface of the side wall 52 of the container member 3A, and an electrode terminal 61B is attached to the outer surface of the side wall 52 of the container member 3B. The electrode terminal 61B is provided on the side on which the electrode terminal 61A is positioned with respect to the electrode groups 5A and 5B in the first direction. The electrode terminals 61A and 61B are disposed on the side on which the leads 21A and 21B are positioned with respect to the electrode groups 5A and 5B in the first direction.

In the present modification, the electrode terminal 61A is electrically connected to the lead 21A in the space 8A, and the electrode terminal 61B is electrically connected to the lead 21B in the space 8B. Therefore, the electrode terminal 61A serves as a positive electrode terminal of the battery 1 and the electrode terminal 61B serves as a negative electrode terminal of the battery 1. The electrode terminal 61A is electrically insulated from the container member 3A by the insulating member 62A or the like disposed on the outer surface of the container member 3A. In addition, the electrode terminal 61B is electrically insulated from the container member 3B by the insulating member 62B or the like disposed on the outer surface of the container member 3B.

With the configuration as described above, in the battery 1 of the present modification, short circuit between the electrode groups 5A and 5B via the electrolyte is effectively prevented in the configuration in which the electrode groups 5A and 5B are provided inside the container members 3A and 3B. That is, in the present modification, the battery 1 is provided which can effectively prevent short circuit due to ionic conduction between the electrode groups 5A and 53 in the configuration in which the electrode groups 5A and 5B are provided inside the container members 3A and 3B.

In the configuration in which the container members 3A and 3B are made of a metal as in the modification of FIG. 7, the metal layers 25 of the sheet member 7 may not be electrically insulated from the container members 3A and 3B. However, in this case as well, the leads 21A and 21B and the electrode terminals 61A and 613 are electrically insulated from the container members 3A and 3B. In the portions other than the opening hole 43, short circuit between the electrode group 5A and the surface 41 of the metal layer 25 via the electrolyte is effectively prevented. In the portions other than the opening hole 45, circuit between the electrode group 5B and the surface 42 of the metal layer 25 via the electrolyte is effectively prevented. In addition, the contact of the electrode group 5A with the container member 3A and the contact of the electrode group 5B with the container member 3B are effectively prevented. The electrical connection of the electrode group 5A to the container member 3A via the electrolyte or the like is effectively prevented, and the electrical connection of the electrode group 5B to the container member 3B via the electrolyte or the like is effectively prevented.

FIG. 8 shows a battery 1 according to a second modification of the first embodiment. In the present modification, as in the first embodiment, each of container members 3A and 3B is made of a laminated film. However, in the present modification, three electrode groups 5A to 5C and two sheet members 7A and 7B are housed inside the container members 3A and 3B. Each of the sheet members 7A and 7B has the same structure as the sheet member 7 of the first embodiment, and includes a metal layer 25 and insulating layers 26 and 27. Opening holes 43 and 45 are formed in each of the sheet members 7A and 7B.

In the present modification, the sheet member 7A is arranged between the electrode groups 5A and 5B in the arranging direction of the electrode groups 5A to 5C (direction indicated by arrows X1 and X2). Therefore, the sheet member 7A serves as a partition wall for isolating the electrode groups 5A and 5B, and the two electrode groups 5A and 5B, which are adjacent to each other, are objects to be isolated by the sheet member 7A. In addition, the sheet member 7B is disposed between the electrode groups 5B and 5C in the arranging direction of the electrode groups 5A to 5C. Therefore, the sheet member 7B serves as a partition wall for isolating the electrode groups 5B and 5C, and the two electrode groups 5B and 5C, which are adjacent to each other, are objects to be isolated by the sheet member 7B. With the configuration as described above, the sheet members 7A and 7B separate the interior of the container members 3A and 3B into a space 8A in which the electrode group 5A is arranged, a space 8B in which the electrode group 5B is arranged, and a space 8C in which the electrode group 5C is arranged.

In the battery 1 of the present modification, leads 21A, 21B, and 22A to 22D are provided. In the present modification, in the electrode group 5A, the lead 21A is connected to a positive electrode current collecting tab 37, and the lead 22A is connected to a negative electrode current collecting tab 33. In addition, in the electrode group 5B, the lead 22B is connected to the positive electrode current collecting tab 37, and the lead 22C is connected to the negative electrode current collecting tab 33. In the electrode group 5C, the lead 22D is connected to the positive electrode current collecting tab 37, and the lead 21B is connected to the negative electrode current collecting tab 33. In the present modification, as in the first embodiment, the leads 21A and 21B protrude to the outside of the container members 3A and 3B, and the protrusion portions to the outside of the container members 3A and 3B in the leads 21A and 21B serve as electrode terminals. In the present modification, the protrusion portion to the outside of the lead 21A serves as a positive electrode terminal of the battery 1, and the protrusion portion to the outside of the lead 21B serves as a negative electrode terminal of the battery 1.

In the present modification, the lead 21B is positioned on the side opposite to the side on which the lead 21A is positioned with respect to the electrode groups 5A and 5C in the first direction. In addition, the leads 22A and 22B are arranged on the side on which the lead 21B is positioned with respect to the electrode groups 5A to 5C in the first direction. The leads 22C and 22D are arranged on the side on which the lead 21A is positioned with respect to the electrode groups 5A to 5C in the first direction. In addition, in the present modification, the opening holes 43 and 45 of the sheet member 7A are positioned on the side on which the leads 21B are positioned with respect to the electrode groups 5A to 5C in the first direction. The opening holes 43 and 45 of the sheet member 7B are positioned on the side on which the leads 21A are positioned with respect to the electrode groups 5A to 5C in the first direction.

In the battery 1 of the present modification, in the opening hole 43 of the sheet member 7A, the lead 22A is connected to the metal layer 25. Therefore, the electrode group 5A, which is one of the electrode groups 5A and 5B to be isolated by the sheet member 7A, is electrically connected to the metal layer 25 through the opening hole (first opening hole) 43. In addition, in the opening hole 45 of the sheet member 7A, the lead 22B is connected to the metal layer 25. Therefore, the electrode group 5B, which is the other of the electrode groups 5A and 5B to be isolated by the sheet member 7A, is electrically connected to the metal layer 25 through the opening hole (second opening hole) 45. Therefore, the leads 22A and 22B and the metal layer 25 of the sheet member 7A form an electric path for electrically connecting the electrode groups 5A and 5B.

Similarly, in the opening hole 43 of the sheet member 7B, the lead 22C is connected to the metal layer 25. Therefore, the electrode group 5B, which is one of the electrode groups 5B and 5C to be isolated by the sheet member 7B, is electrically connected to the metal layer 25 through the opening hole (first opening hole) 43. In addition, in the opening hole 45 of the sheet member 7B, the lead 22D is connected to the metal layer 25. Therefore, the electrode group 5C, which is the other of the electrode groups 5B and 5C to be isolated by the sheet member 7B, is electrically connected to the metal layer 25 through the opening hole (second opening hole) 45. Therefore, the leads 22C and 22D and the metal layer 25 of the sheet member 7B form an electric path which electrically connects the electrode groups 5B and 5C. Since the electrode groups 5A to 5C are connected as described above, the electrode groups 5A to 5C are electrically connected in series to each other.

In the present modification as well, a sealing portion 46 is provided as in the first embodiment. In the sealing portion 46, the insulating layer (first insulating layer) 26 of the sheet member 7A is directly fused to the resin layer 12 of the container member 3A (the inner surface of the container member 3A), except for the portion in which the lead 21A extends to the outside. In addition, in the sealing portion 46, the insulating layer (second insulating layer) 27 of the sheet member 7A is directly fused to the insulating layer (first insulating layer) 26 of the sheet member 7B. In the sealing portion 46, the insulating layer (second insulating layer) 27 of the sheet member 7B is directly fused to the resin layer 12 of the container member 3B (the inner surface of the container member 3B), except for the portion in which the lead 21B extends to the outside.

In the portion in which the lead 21A extends to the outside in the sealing portion 46, the lead 21A is interposed between the sheet member 7A and the container member 3A. Therefore, in the portion in which the lead 21A extends to the outside in the sealing portion 46, the insulating layer (first insulating layer) 26 of the sheet member 7A is fused to the resin layer 12 of the container member 3A (the inner surface of the container member 3A) via the band 47A of the lead 21A. In the portion in which the lead 21B extends to the outside in the sealing portion 46, the lead 21B is interposed between the sheet member 7B and the container member 3B. Therefore, in the portion in which the lead 21B extends to the outside in the sealing portion 46, the insulating layer (second insulating layer) 27 of the sheet member 7B is fused to the resin layer 12 of the container member 3B (the inner surface of the container member 3B) via the band 47B of the lead 21B. As described above, in the present modification, the insulating layer (26, 27) of each of the sheet members 7A and 7B is fused to one of the resin layers (12) of the container members 3A and 3B and the insulating layer (26, 27) of the other sheet member (7A, 7B).

By forming the sealing portion 46 as described above, the sheet members 7A and 7B are firmly attached to the container members 3A and 3B, and the electrode groups 5A to 5C are appropriately isolated in the interior of the container members 3A and 3B. In addition, the electrical insulation of the metal layers 25 of the sheet member 7A and 7B with respect to the leads 21A and 21B is properly secured by providing the insulating layers 26 and 27 of each of the sheet members 7A and 7B and the bands 47A and 47B. In addition, the electrical insulation between the metal layers 25 of the sheet members 7A and 7B is also properly secured.

In the present modification, the electrode group 5A is electrically connected to the metal layer 25 of the sheet member 7A only in the opening hole 43, and the electrode group 5B is electrically connected to the metal layer 25 of the sheet member 7A only in the opening hole 45. In the sheet member 7A of the present modification, the insulating layer 26 effectively prevents short circuit between the electrode group 5A and the surface 41 of the metal layer 25 via the electrolyte in portions other than the opening hole 43. Similarly, in the sheet member 7A, the insulating layer 27 effectively prevents short circuit between the electrode group 5B and the surface 42 of the metal layer 25 via the electrolyte in portions other than the opening hole 45. Therefore, short circuit due to ionic conduction between each of the electrode groups 5A and 5B and the metal layer 25 of the sheet member 7A is effectively prevented.

In addition, in the present modification, the electrode group 5B is electrically connected to the metal layer 25 of the sheet member 7B only in the opening hole 43, and the electrode group 5C is electrically connected to the metal layer 25 of the sheet member 7B only in the opening hole 45. In the sheet member 7B of the present modification, the insulating layer 26 effectively prevents short circuit between the electrode group 5B and the surface 41 of the metal layer 25 via the electrolyte in portions other than the opening hole 43. Similarly, in the sheet member 7B, the insulating layer 27 effectively prevents short circuit between the electrode group 5C and the surface 42 of the metal layer 25 via the electrolyte in portions other than the opening hole 45. Therefore, short circuit due to ionic conduction between each of the electrode groups 5B and 5C and the metal layer 25 of the sheet member 7B is effectively prevented.

With the configuration as described above, in the battery 1 of the present modification, short circuit between the electrode groups 5A to 5C via the electrolyte is effectively prevented in the configuration in which the electrode groups 5A to 5C are provided inside the container members 3A and 3B. That is, in the present modification, the battery 1 is provided which can effectively prevent short circuit due to ionic conduction between the electrode groups 5A to 5C in the configuration in which the electrode groups 5A to 5C are provided inside the container members 3A and 3B.

In certain modification, four or more electrode groups (5) may be provided inside the container members 3A and 3B. For example, in the case in which four electrode groups (5) are provided, a configuration that effectively prevents short circuit due to ionic conduction between the four electrode groups (5) is realized by providing three sheet members similar to the sheet member 7. Therefore, in the case in which N (N is plural) electrode groups (5) are provided inside the container members 3A and 3B, a configuration that effectively prevents short circuit due to ionic conduction between the N electrode groups (5) is realized by providing N−1 sheet members similar to the sheet member 7.

In addition, in certain modification, in the configuration in which three or more electrode groups (5) are provided inside the container members 3A and 3B, metallic containers may be used as the container members 3A and 3B as in the modification of FIG. 7, instead of making the container members 3A and 3B of the laminated film.

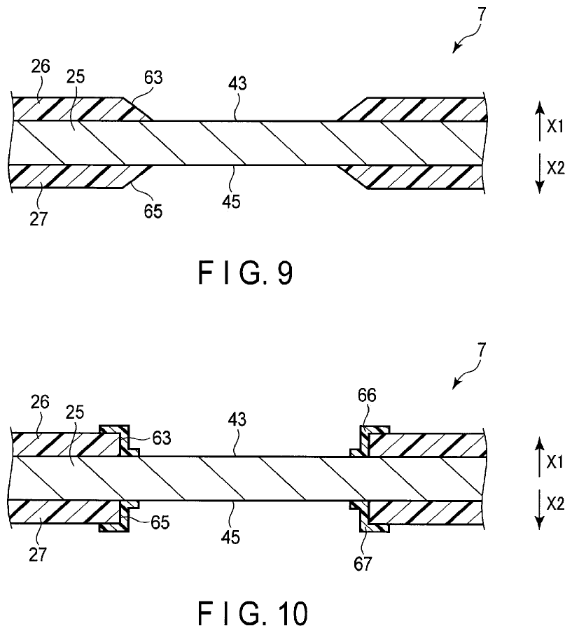

In addition, in a third modification of the first embodiment shown in FIG. 9, in a sheet member 7 (7A, 7B), an edge surface (first edge surface) 63 of an insulating layer 26 is formed in a tapered shape, and an edge surface (second edge surface) 65 of an insulating layer 27 is formed in a tapered shape. Therefore, in an opening hole (first opening hole) 43 of the sheet member 7 (7A, 7B), a cross-sectional area of the opening hole 43 decreases as approaching a metal layer 25. Similarly, in an opening hole (second opening hole) 45 of the sheet member 7 (7A, 7B), a cross-sectional area of the opening hole 45 decreases as approaching the metal layer 25.

Since the edge surface 63 is formed in the tapered shape, the insulating layer 26 is hardly peeled off in the opening hole 43. Similarly, since the edge surface 65 is formed in the tapered shape, the insulating layer 27 is hardly peeled off in the opening hole 45. Since each of the insulating layers 26 and 27 is hardly peeled off from the metal layer 25, deterioration of the sheet member 7 (7A, 7B) is reduced and the life of the sheet member 7 (7A, 7B) and the battery 1 is prolonged.

In certain modification, in the sheet member 7 (7A, 7B), only one of the edge surfaces 63 and 65 may be formed in a tapered shape as in the modification of FIG. 9.

In addition, in a fourth modification of the first embodiment shown in FIG. 10, in a sheet member 7 (7A, 7B), an adhesive layer (first adhesive layer) 66 is formed on an edge surface (first edge surface) 63 of an insulating layer 26, and adhesive layer (second adhesive layer) 67 is formed on an edge surface (second edge surface) 65 of an insulating layer 27. Each of the adhesive layers 66 and 67 is formed by an adhesive agent or an adhesive tape.

Since the adhesive layer 66 is formed on the edge surface 63, the insulating layer 26 is hardly peeled off in an opening hole 43. Similarly, since the adhesive layer 67 is formed on the edge surface 65, the insulating layer 27 is hardly peeled off in an opening hole 45. Therefore, in the present modification as well, each of the insulating layers 26 and 27 is difficult to peel off from the metal layer 25, as in the modification of FIG. 9. Therefore, in the present modification as well, deterioration of the sheet member 7 (7A, 7B) is reduced and the life of the sheet member 7 (7A, 7B) and the battery 1 is prolonged.

In certain modification, in the sheet member 7 (7A, 7B), the adhesive layer (66, 67) may be formed on only one of the edge surfaces 63 and 65, as in the modification of FIG. 10.

(Details of Each Element)

Hereinafter, each element of the battery 1 of the above-described embodiment and the like (including the modifications) will be described in detail. In the following description, the container members 3A and 3B, the negative electrode 15, the positive electrode 17, the separator 16, the electrode terminal, the electrolyte, and the sheet member 7 (7A, 7B) will be described in detail.

1) Container Member

As the container member, either a bag-shaped container made of a laminated film or a metallic container can be used. Examples of the shape of the container member include a flat shape, a rectangular shape, a cylindrical shape, a coin shape, a button shape, a sheet shape, and a stack shape.

As the laminated film, for example, a multilayer film can be used, and the multilayer film can include a plurality of resin layers and a metal layer disposed between the resin layers. In this case, from the viewpoint of a weight reduction, the metal layer is preferably an aluminum foil or an aluminum alloy foil. As the resin layer, for example, a polymeric material such as polypropylene (PP), polyethylene (PE), nylon, or polyethylene terephthalate (PET) can be used. For example, the laminated film is heat-sealed to be formed into the shape of a container member. The thickness of the laminated film is preferably 0.5 mm or less, and more preferably 0.2 mm or less.

The metallic container is preferably made of at least one metal selected from the group consisting of iron, aluminum, zinc, and titanium, or an alloy of these metals. Specifically, examples of the alloy include an aluminum alloy and stainless steel. The metallic container has a thickness of, preferably 0.5 mm or less, and more preferably 0.2 mm or less.

2) Negative Electrode

The negative electrode includes a negative electrode current collector and a negative electrode mixture layer disposed on the negative electrode current collector. The negative electrode mixture layer can be disposed on one surface or each of both surfaces of the negative electrode current collector. The negative electrode mixture layer contains a negative electrode active material, and the negative electrode mixture layer may further contain a conductive agent and a binder.

As the negative electrode active material, a material that inserts and extracts lithium ions can be used, and a metal oxide or a metal sulfide can be used. In particular, as the negative electrode active material, a titanium-containing oxide is preferably selected. In the titanium-containing oxide used as the negative electrode active material, a Li insertion potential is in a range of 1 V (vs. Li/Li⁺) or more and 3 V (vs. Li/Li⁺) or less. Examples of the titanium-containing oxide include a titanium oxide, a lithium titanium oxide, a niobium titanium-containing complex oxide, and a sodium niobium titanium-containing composite oxide. Here, when the Li insertion potential of the negative electrode active material is lower than 1 V, a side reaction between the negative electrode active material and the electrolytic solution may occur. On the other hand, when the Li insertion potential of the negative electrode active material is more than 3 V, the battery voltage is decreased. The negative electrode active material may contain one or two more of the above-described titanium-containing oxides. Among the electrode groups provided in the battery, all of the electrode groups may contain the titanium-containing oxide as the negative electrode active material, and in order to obtain the intended characteristics, only a part of the electrode groups may contain the titanium-containing oxide as the negative electrode active material. Therefore, at least one of the electrode groups provided in the battery may include the titanium-containing oxide as the negative electrode active material.

Examples of the titanium oxide include a titanium oxide having a monoclinic structure, a titanium oxide having a rutile structure, and a titanium oxide having an anatase structure. The titanium oxide having each crystal structure can be represented by TiO₂ as an uncharged composition and LiₓTiO₂ (x: 0≤x≤1) as a charged composition. The uncharged structure of the titanium oxide having a monoclinic structure can be represented as TiO₂(B). An orthorhombic titanium oxide can be represented by the general formula Li₂₊ₐM1_{2-b}Ti_{6-c}M2_{d}O_{14+σ} (0≤a≤6, 0<b<2, 0<c<6, 0<d<6, −0.5≤σ≤0.5 (M1=Sr, Ba, Ca, Mg, Na, Cs, and K, M2=Zr, Sn, V, Nb, Ta, Mo, W, Fe, Co, Mn, Al, and Y).

Examples of the lithium-titanium-containing composite oxide include a lithium titanium oxide having a spinel structure (for example, the general formula: Li₄₊ₓTi₅O₁₂ (−1≤x≤3)), a lithium titanium oxide having a ramsdellite structure (for example, Li₂₊ₓTi₃O₇ (−1≤x≤3), Li₁₊ₓTi₂O₄ (0≤x≤1), Li_{1.1+x}Ti_{1.8}O₄ (0≤x≤1), Li_{1.07+x}Ti_{1.86}O₄ (0≤x≤1), and LiₓTiO₂ (0<x≤1). Examples of the lithium titanium oxide include a lithium titanium composite oxide in which a dopant is introduced into the above-described lithium titanium oxide having a spinel structure or a ramsdellite structure.

Examples of the niobium-titanium-containing composite oxide include a monoclinic niobium titanium composite oxide represented by LiₐTiM_{b}Nb_{2±β}O_{7±σ} (0≤a≤5, 0≤b≤0.3, 0≤β≤0.3, 0≤σ≤0.3, M is at least one element selected from the group consisting of Fe, V, Mo, and Ta).

Examples of the sodium-niobium-titanium-containing composite oxide include an orthorhombic Na-containing niobium titanium composite oxide represented by the general formula Li₂₊ᵥNa_{2-w}M1ₓTi_{6-y-z}Nb_{y}M2_{z}O_{14+δ} (0≤v≤4, 0<w<2, 0≤x<2, 0<y≤6, 0≤z<3, y+z<6, −0.5≤δ≤0.5; M1 contains at least one selected from group consisting of Cs, K, Sr, Ba, and Ca; and M2 contains at least one selected from group consisting of Zr, Sn, V, Ta, Mo, W, Fe, Co, Mn, and Al).

In addition, the negative electrode active material can include carbonaceous materials such as graphite, silicon, and silicon oxide. Graphite contained in the negative electrode active material inserts and extracts lithium. Examples of the graphite material include artificial graphite and natural graphite. The artificial graphite can be obtained by heat-treating carbon precursors, such as petroleum or coal derived pitch, synthetic pitch, mesophase pitch, coke, or resin, at 2,000 to 3,000° C. under an inert atmosphere.

Examples of the conductive agent include carbonaceous materials such as acetylene black, carbon black, graphite, carbon nanofibers, and carbon nanotubes. As the conductive agent, one of the above-described carbonaceous materials may be used alone, or a plurality of carbonaceous materials of the above-described carbonaceous materials may be used.

The binder of the negative electrode mixture layer binds the active material, the conductive agent, and the current collector. Examples of the binder include polytetrafluoroethylene (PTFE), polyvinylidene fluoride (PVdF), fluorocarbon rubber, styrene-butadiene rubber, acrylic resin, and cellulose. Examples of cellulose used for the binder include carboxymethyl cellulose.

The proportions of the negative electrode active material, conductive agent, and binder in the negative electrode mixture layer are preferably as follows: the negative electrode active material: 70% by weight or more and 96% by weight or less, the conductive agent: 2% by weight or more and 28% by weight or less, and the binder: 2% by weight or more and 28% by weight or less. When the amount of the electro-conductive agent is 2% by weight or more, the current collection performance of the negative electrode mixture layer can be improved and the high current performance of the battery can be improved. In addition, since the amount of the binder is 2% by weight or more, the binding property between the negative electrode mixture layer and the negative electrode current collector can be improved, and the cycle performance can be improved. On the other hand, from the viewpoint of an increase in a capacity, the amount of the conductive agent is preferably 28% by weight or less, and the amount of the binder is preferably 28% by weight or less.

The negative electrode current collector is a metal body, and the metal body contains at least one metal selected from the group consisting of aluminum, copper, zinc, nickel, titanium, and stainless steel. The metal body can contain one metal of the above-described metals. The metal body can contain two or more metals of the above-described metals. In certain Example, the metal body is, for example, a metal foil made of one of the above-described metals. In another Example, the metal body is an alloy foil containing, for example, two or more of the above-described metals. Examples of the shape of the metal body include a mesh shape and a porous body shape, besides the foil. From the viewpoint of improving an energy density and output, it is desirable that the metal body is a foil shape, which has a small volume and has a large surface area.

The negative electrode can be produced, for example, by the following method. First, the negative electrode active material, the conductive agent, and the binder are suspended in a solvent, to prepare a slurry. Then, the prepared slurry is applied to one or each of both of surfaces of the negative electrode current collector. By drying the coating film on the negative electrode current collector, the negative electrode mixture layer is formed. Thereafter, the negative electrode current collector and the negative electrode mixture layer formed on the negative electrode current collector are pressed. In place of pressing, the negative electrode active material, the conductive agent, and the binder may be formed in a pellet form, and used as the negative electrode mixture layer.

3) Positive Electrode

The positive electrode includes a positive electrode current collector and a positive electrode mixture layer disposed on the positive electrode current collector. The positive electrode mixture layer can be disposed on one surface or each of both surfaces of the positive electrode current collector. The positive electrode mixture layer contains a positive electrode active material, and the positive electrode mixture layer may further contain a conductive agent and a binder.

As the positive electrode active material, for example, a compound capable of inserting and extracting lithium can be used. Examples of the compound used for the positive electrode active material include a metal oxide and a polymer. As the positive electrode active material, one of the following active materials may be used alone, or two or more of the following active materials may be used.

Examples of the metal oxide used as the positive electrode active material include a manganese dioxide, an iron oxide, a copper oxide, a lithium manganese composite oxide, a lithium nickel composite oxide, a lithium cobalt aluminum composite oxide, a lithium nickel cobalt manganese composite oxide, a spinel type lithium manganese nickel composite oxide, a lithium manganese cobalt composite oxide, a lithium iron oxide, a lithium fluorinated iron sulfate, a phosphoric acid compound having an olivine crystal structure (for example, LiₓFePO₄ (0≤x≤1), LiₓMnPO₄ (0≤x≤1)), and a nickel cobalt manganese-containing composite oxide (LiₓNi_{1-y-z}Co_{y}Mn_{z}O₂; 0<x≤1, 0<y<1, 0<z<1, y+z<1). The phosphate compound having an olivine crystal structure has excellent thermal stability.

In addition, examples of the polymer used as the positive electrode active material include a conductive polymer, such as polyaniline and polypyrrole, and a disulfide-based polymer. In addition, sulfur and fluorine carbon and the like can also be used as the positive electrode active material.

In addition, from the viewpoint of obtaining a high positive electrode potential, the following materials are preferably used as the positive electrode active material. That is, preferred examples of the positive electrode active material include a lithium manganese composite oxide such as LiₓMn₂O₄ (0<x≤1) and LiₓMnO₂ (0<x≤1), a nickel cobalt manganese-containing composite oxide such as LiₓNi_{1-y-z}Co_{y}Mn_{z}O₂ (0<x≤0<y<1, 0<z<1, y+z<1), a lithium nickel aluminum composite oxide such as LiₓNi_{1-y}Al_{y}O₂ (0<x≤1, 0<y≤1), a lithium cobalt composite oxide such as LiₓCoO₂ (0<x≤1), a lithium nickel cobalt composite oxide such as LiₓNi_{1-y-1}Co_{y}Mn_{z}O₂ (0<x≤1, 0<y≤1, 0≤z≤1), a lithium manganese cobalt composite oxide such as LiₓMn_{y}Co_{1-y}O₂ (0<x≤1, 0<y≤1), a spinel-type lithium manganese nickel composite oxide such as LiₓMn_{2-y}Ni_{y}O₄ (0<x≤1, 0<y<2), a lithium phosphate having an olivine structure such as LiₓFePO₄ (0<x≤1), LiₓFe_{1-y}Mn_{y}PO₄ (0<x≤1, 0≤y≤1), and LiₓCoPO₄ (0<x≤1), and a fluorinated iron sulfate such as LiₓFeSO₄F (0<x≤1).

The positive electrode mixture layer can contain the same conductive agent as the conductive agent contained in the negative electrode mixture layer. In this case, examples of the conductive agent include carbonaceous materials such as acetylene black, carbon black, graphite, carbon nanofibers, and carbon nanotubes. As the conductive agent of the positive electrode mixture layer, one of the above-described carbonaceous materials may be used alone, or a plurality of carbonaceous materials of the above-described carbonaceous materials may be used.

As with the binder of the negative electrode mixture layer, the binder binds the active material, the conductive agent, and the current collector in the positive electrode mixture layer. The positive electrode mixture layer can contain the same binder as the binder contained in the negative electrode mixture layer. In this case, examples of the binder include polytetrafluoroethylene (PTFE), polyvinylidene fluoride (PVdF), fluorocarbon rubber, acrylic resin, and cellulose, and examples of cellulose used for the binder include carboxymethyl cellulose.

The proportions of the positive electrode active material, conductive agent, and binder in the positive electrode mixture layer are preferably as follows: the positive electrode active material: 80% by weight or more and 95% by weight or less, the conductive agent: 3% by weight or more and 18% by weight or less, and the binder: 2% by weight or more and 17% by weight or less. By setting the proportion of the conductive agent to 3% by weight or more, the conductivity of the positive electrode can be secured. By setting the proportion of the conductive agent to 18% by weight or less, the decomposition of the electrolytic solution on the surface of the conductive agent in high-temperature storage can be reduced. By setting the proportion of the binder to 2% by weight or more, sufficient electrode strength is obtained. By setting the proportion of the binder to 17% by weight or less, the blending amount of the binder serving as the insulating material in the positive electrode is decreased, whereby the internal resistance can be reduced.

The positive electrode current collector is a metal body containing the same metal as the metal forming the negative electrode current collector. The positive electrode current collector can be formed in the same shape as that of the negative electrode current collector, for example, in the form of the metal foil. In addition, the positive electrode can be produced by using the above-described positive electrode active material by, for example, the same method as the method of producing the negative electrode.

4) Separator

A porous film and a nonwoven fabric or the like which are made of a synthetic resin can be used as a separator. In this case, examples of the material forming the porous film and the nonwoven fabric include polyethylene (PE), polypropylene (PP), cellulose, glass fiber, and polyvinylidene fluoride (PVdF). Among the above-described materials, cellulose has excellent Li diffusibility or the like. For this reason, cellulose is preferably used as the material forming the separator.

5) Electrode Terminal

The electrode terminal can include, for example, an external terminal and an internal terminal. In certain Example, the external terminal is, for example, a conductive tab of an electrode (positive electrode and negative electrode). In another Example, a container member having conductivity such as a metal can be provided as a container member of the battery, and an external terminal can also be formed in the container member. The internal terminal includes, for example, an electrode lead. The shape of the internal terminal is not particularly limited, and the internal terminal is formed in, for example, a strip shape, a disc shape, a washer shape, a spiral shape, or a corrugated plate shape or the like.

The electrode terminal is preferably formed of at least one metal selected from the group consisting of aluminum, zinc, titanium and iron, or an alloy of these metals. Examples of the alloy include an aluminum alloy and stainless steel.

6) Electrolyte

A nonaqueous electrolytic solution can be used as the electrolyte. The nonaqueous electrolytic solution which is the nonaqueous electrolyte is prepared by dissolving an electrolyte in an organic solvent. In the nonaqueous electrolytic solution, the concentration of the electrolyte is preferably 0.5 mol/L or more and 2.5 mol/L or less.

Examples of the electrolyte to be dissolved in the organic solvent include lithium salts such as lithium perchlorate (LiClO₄), lithium hexafluorophosphate (LiPF₆), lithium tetrafluoroborate (LiBF₄), lithium hexafluoroarsenide (LiAsF₆), lithium trifluoromethanesulfonate (LiCF₃SO₃) and lithium bistrifluoromethylsulfonylimide [LiN(CF₃SO₂)₂], and mixtures thereof. The electrolyte is preferably resistant to oxidation even at a high electric potential, and LiPF₆ is most preferably used as the electrolyte.

Examples of the organic solvent in which the electrolyte is dissolved include cyclic carbonates such as propylene carbonate (PC), ethylene carbonate (EC), and vinylene carbonate; chain carbonates such as diethyl carbonate (DEC), dimethyl carbonate (DMC), and methyl ethyl carbonate (MEC); cyclic ethers such as tetrahydrofuran (THF), 2-methyl tetrahydrofuran (2MeTHF), and dioxolane (DOX); chain ethers such as dimethoxy ethane (DME) and diethoxy ethane (DEE); γ-butyrolactone (GBL), acetonitrile (AN), and sulfolane (SL). These organic solvents can be used alone or as a mixed solvent.

As the organic solvent, a mixed solvent obtained by mixing at least two materials selected from the group consisting of propylene carbonate (PC), ethylene carbonate (EC), and diethyl carbonate (DEC), or a mixed solvent containing γ-butyrolactone (GBL) is preferably used. The use of these mixed solvents improves the high temperature characteristics of the battery.

A gel nonaqueous electrolyte can be used in place of the nonaqueous electrolytic solution. The gel nonaqueous electrolyte is prepared by combining the above-described nonaqueous electrolytic solution with a polymeric material. Examples of the polymeric material to be combined with the nonaqueous electrolytic solution include polyvinylidene fluoride (PVdF), polyacrylonitrile (PAN) and polyethylene oxide (PEO), and mixtures thereof.

As the nonaqueous electrolyte, a room-temperature molten salt (ionic melt) containing lithium ions, or a solid electrolyte may be used in place of the nonaqueous electrolytic solution and the gel nonaqueous electrolyte. Examples of the solid electrolyte include a polymer solid electrolyte and an inorganic solid electrolyte.

The room-temperature molten salt (ionic melt) means a compound which is an organic salt containing an organic cation and an organic anion, and can exist as a liquid by itself at normal temperature (15 to 25° C.). The room-temperature molten salt includes a room-temperature molten salt which exists alone as a liquid, a room-temperature molten salt which becomes a liquid after being mixed with an electrolyte, a room-temperature molten salt which becomes a liquid after being dissolved in an organic solvent, and mixtures thereof. In general, the melting point of the room-temperature molten salt used as the nonaqueous electrolyte in nonaqueous electrolyte batteries is 25° C. or lower. The organic cation which is the composition of the room-temperature molten salt generally has a quaternary ammonium skeleton.

The polymer solid electrolyte is prepared by dissolving an electrolyte in a polymeric material, and solidifying it. The inorganic solid electrolyte is a solid substance having Li ion conductivity.

In addition, as described above, when the solid electrolyte is used as the nonaqueous electrolyte, the solid electrolyte may be used as the separator, and the positive electrode and the negative electrode may be electrically insulated by the solid electrolyte. The solid electrolyte used as the separator is preferably an oxide such as LATP (Li₁₊ₓAlₓTi₂₋ₓ(PO₄)₃; 0.1≤x≤0.4) having a NASICON skeleton, amorphous LIPON (Li_{2.9}PO_{3.3}N_{0.46}), and garnet type LLZ (Li₇La₃Zr₂O₁₂).

However, the ion conductivity of the solid electrolyte is lower than that of the nonaqueous electrolyte and the gel nonaqueous electrolyte. For example, the ion conductivity of the solid electrolyte is about 1/100 or more and 1/10 or less of the ion conductivity of the nonaqueous electrolytic solution. Therefore, from the viewpoint of securing the high output density of the battery, an electrolytic solution (nonaqueous electrolytic solution) or a gel electrolyte (gel nonaqueous electrolyte) is preferably used as the electrolyte (nonaqueous electrolyte) held (impregnated) in the electrode group.

7) Sheet Member

In the sheet member, an insulating layer is laminated on both surfaces of a metal layer. In the insulating layer, an opening hole is formed as described above. The metal layer has conductivity. In addition, from the viewpoint of a weight reduction, the metal layer is preferably made of aluminum or an aluminum alloy. The insulating layer is made of a resin having electrical insulation properties and thermal adhesiveness. Examples of the resin for forming the insulating layer include a polymer material such as polypropylene (PP) and polyethylene (PE).

When a container member is a laminated film, the insulating layer of the sheet member is preferably made of the same polymer material as the resin layer of the laminated film. Therefore, the adhesiveness between the sheet member and the container member is improved.

(Function and Effect)

The battery 1 according to the above-described embodiment and the like has the following function and effect. That is, in the above-described embodiment and the like, the short circuit between the electrode groups (5) via the electrolyte is effectively prevented in the configuration in which the electrode groups (5) are provided inside the container members 3A and 3B. That is, the short circuit between the electrode groups (5) due to the ionic conduction is also effectively prevented in the configuration in which the electrode groups (5) are provided inside the container members 3A and 3B. Therefore, in the battery 1, the electrode groups (5) can be arranged inside the container members 3A and 3B. Therefore, the high voltage can be obtained from only one battery 1.

In addition, the high voltage can be obtained by using the battery 1 of the above-described embodiment and the like, without connecting a plurality of batteries in series. Therefore, the high voltage can be obtained by using the battery 1, without enlarging the entire device including the battery 1. Therefore, the high voltage can be obtained while maintaining the energy density of the entire device including the battery 1 high.

In addition, in the battery 1 of the above-described embodiment and the like, since the short circuit between the electrode groups (5) due to the ionic conduction inside the container members 3A and 3B is effectively prevented, the liquid electrolyte (nonaqueous electrolytic solution) and the softened gel electrolyte (gel nonaqueous electrolyte) can be used as the electrolyte (nonaqueous electrolyte). The gel electrolyte and the electrolytic solution have higher ion conductivity than that of the solid electrolyte. The high output density of the battery 1 can be secured by using the gel electrolyte or the electrolytic solution having high ion conductivity as the electrolyte. Therefore, in the above-described embodiment and the like, the battery 1 having high output density and high voltage can be provided by using the gel electrolyte or the electrolytic solution as the electrolyte.

[Battery Pack]

Next, a battery pack in which the battery of the above-described embodiment and the like is used will be described. The battery pack includes a battery module. The battery module includes plural of the battery of the above-described embodiment and the like. In the battery module, a plurality of the batteries are electrically connected in at least one of series and parallel. In addition, in the battery pack, only one battery of the above-described embodiment and the like may be provided instead of the battery module.

In the battery module provided in the battery pack, each of the batteries is electrically connected to another battery. In the battery of the above embodiment and the like, the positive electrode terminal and the negative electrode terminal are provided as the electrode terminals. In the battery module, the electrode terminal of each of the batteries is connected to a corresponding electrode terminal of another battery via a connection member such as a metal bus bar. Examples of the metal forming the bus bar include aluminum, nickel, and copper. Note that two batteries are electrically connected in parallel by connecting the positive electrode terminals and connecting the negative electrode terminals between the two batteries. In addition, two batteries are electrically connected in series by connecting the positive electrode terminal of one of the two batteries to the negative electrode terminal of the other of the two batteries.

The battery pack may further include an energizing external terminal. The external terminal is connected to an external device of the battery pack. The external terminal is used to output a current from the battery module to the outside and/or to input a current to the battery module. When the battery module is used as the electric power source, a current is supplied to the outside of the battery pack through the energizing external terminal. When the battery module is charged, a charge current is supplied to the battery module through the energizing external terminal. Examples of the charge current of the battery module include a regenerative energy due to the mechanical power of an automobile or the like.

The battery pack can include a current detection detector, and the like. The current detection circuit may detect the input current to the battery module and the output current from the battery module, or may detect the current flowing through any one of the batteries forming the battery module. In addition, the voltage detection circuit may detect the voltage applied to the entire battery module, or may detect the voltage applied to any one of the batteries forming the battery module. Furthermore, the temperature detector detects the temperature of each of the batteries forming the battery module.

The battery pack may further include a protective circuit. The protective circuit has a function capable of interrupting the electrical connection between the battery module and the external terminal. In the protective circuit, a relay, a fuse, or the like is provided as a connection blocking unit.

In addition, the protective circuit has a function of controlling the charge and discharge of the battery module. The protective circuit controls the charge and discharge of the battery module based on the detection result of any one of the current detection circuit, the voltage detection circuit, the temperature detector, and the like. Therefore, in the battery module, the charge and discharge of each of the batteries is controlled. For example, the protective circuit blocks the electrical connection between the battery module and the external terminal based on the detection of the overcurrent of the battery module in the current detection circuit. Therefore, the input of the current to the battery module and the output of the current from the battery module are stopped.

In certain embodiment, a circuit formed in a device using the battery pack (battery module) as the electric power supply may be used as the protective circuit. Examples of the device using the battery pack as the electric power source include an electronic device and an automobile.

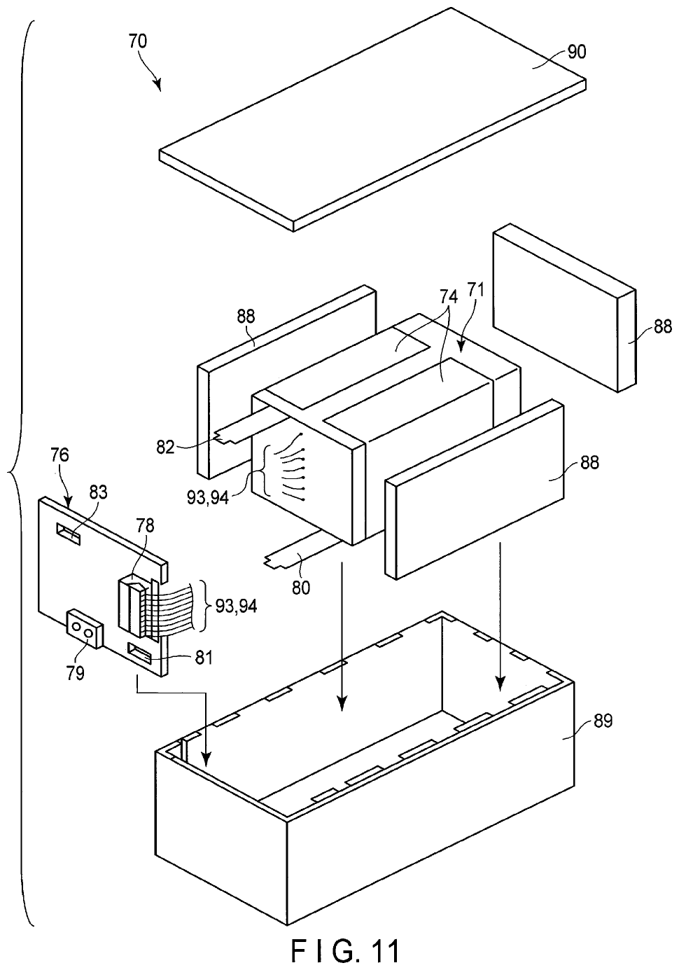

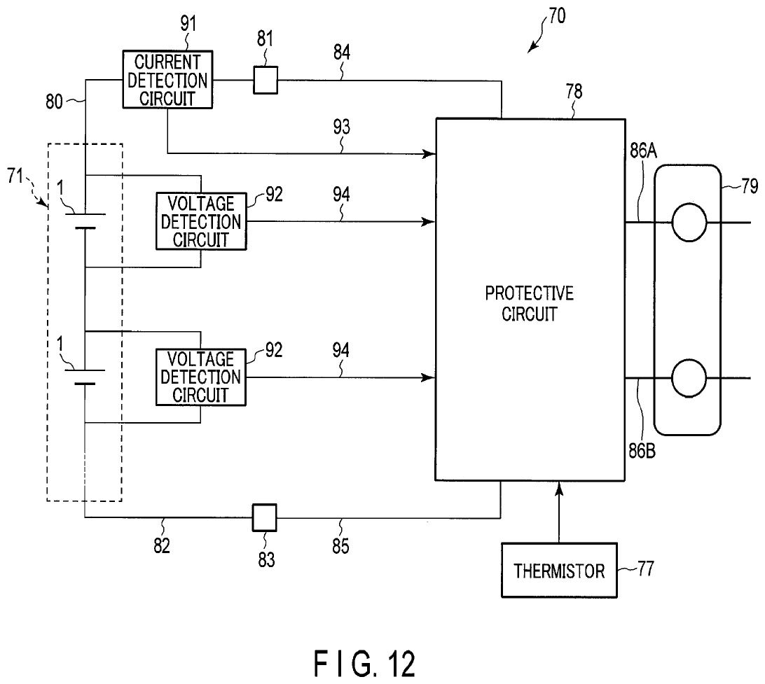

FIGS. 11 and 12 show an example of a battery pack using the battery of the above-described embodiment and the like. FIG. 11 is an exploded perspective view of a battery pack 70. FIG. 12 is a view showing a circuit configuration of the battery pack 70 of FIG. 11.

In one example of FIGS. 11 and 12, the battery pack includes the battery module 71, and the battery module 71 includes a plural of the battery 1 of the above-described embodiments. In the battery module 71, a plurality of batteries 1 are stacked, and the stacked batteries 1 are fastened with an adhesive tape 74 or the like. In the battery module 71, each of the batteries 1 is electrically connected to the corresponding other battery 1 via the above-described electrode terminals (positive electrode terminal and negative electrode terminal). In one example of FIGS. 11 and 12, in the battery module 71, the plurality of batteries are connected in series.

In the battery pack 70, a printed wiring board 76 is disposed to face the battery module 71. A thermistor 77, a protective circuit 78, and an energizing external terminal are mounted on the printed wiring board 76. An insulating plate (not shown) is preferably attached to the surface of the printed wiring board 76 which faces the battery module 71. This prevents unnecessary connection between an electric path on the printed wiring board 76 and the wiring of the battery module 71.

In the battery pack 70, a positive electrode lead 80 and a negative electrode lead 82 are connected to the battery module 71. In one embodiment, one end of the positive electrode lead 80 is connected to the positive electrode terminal in one of the batteries 1 forming the battery module 71. The other end of the positive electrode lead 80 is electrically connected to a positive electrode connector 81 of the printed wiring board 76. In addition, one end of the negative electrode lead 82 is connected to the negative electrode terminal in one of the batteries 1 forming the battery module 71, which is different from the battery 1 to which the positive electrode lead 80 is connected. The other end of the negative electrode lead 82 is electrically connected to a negative electrode connector 83 of the printed wiring board 76. The positive electrode connector 81 is connected to the protective circuit 78 via a wiring 84 formed on the printed wiring board 76, and the negative electrode connector 83 is connected to the protective circuit 78 via a wiring 85 formed on the printed wiring board 76.

In the battery module 71 of the battery pack 70, a protective sheet 88 is disposed on each of three side surfaces excluding a side surface facing the printed wiring board 76. The protective sheet 88 is formed of rubber or resin. The battery module 71 is stored in a housing container 89 together with the protective sheet 88 and the printed wiring board 76. The battery module 71 is located in a space surrounded by the protective sheets 88 and the printed wiring board 76. A lid 90 is attached to the upper surface of the housing container 89.

The thermistor 77 detects the temperature of each of the plurality of batteries 1 which constitutes the battery module 71. The thermistor 77 outputs a detection signal of the temperature to the protective circuit 78.

In addition, a current detection circuit 91 and a voltage detection circuit 92 are provided in the battery pack 70. In the examples of FIGS. 11 and 12, the current detection circuit 91 detects the input current to the battery module 71 and the output current from the battery module 71. In addition, in the examples of FIGS. 11 and 12, the same number of voltage detection circuits 92 as the batteries 1 are provided, and each of the voltage detection circuits 92 detects the voltage of corresponding one of the batteries 1 in the battery module 71. The current detection circuit 91 is connected to the protective circuit 78 via a wiring 93, and each of the voltage detection circuits 92 is connected to the protective circuit 78 via a wiring 94. The current detection circuit 91 outputs a detection signal related to a current to the protective circuit 78 via the wiring 93. In addition, each of the voltage detection circuits 92 outputs a detection signal related to a voltage to the protective circuit 78 via the wiring 94.

In certain Example, in place of detecting the voltage of each of the batteries 1, a positive electrode electric potential or a negative electrode electric potential is detected for each of the batteries 1 constituting the battery module 71. In this case, a lithium electrode or the like as a reference electrode is provided in the battery module 71. With reference to an electric potential at the reference electrode, a positive electrode electric potential or a negative electrode electric potential of each of the batteries 1 is detected.

The protective circuit 78 may determine whether or not the battery module 71 satisfies a predetermined condition based on each of the detection results of the thermistor 77, the current detection circuit 91, and the voltage detection circuits 92. For example, when the detected temperature of the thermistor 77 is equal to or higher than a predetermined temperature, the protective circuit 78 determines that the battery module 71 satisfies a predetermined condition. When any of over-charge, over-discharge, and over-current or the like is detected in the battery module 71, the protective circuit 78 determines that the battery module 71 satisfies a predetermined condition. The over-charge or the like is determined based on the detection results of the current detection circuit 91, for example. The over-charge or the like may be determined for the entire battery module 71 or may be determined for each of the plurality of batteries 1.

In the battery pack 70, the energizing external terminal 79 is provided. The protective circuit 78 can be connected to the external terminal 79 via a plus wiring 86A and a minus wiring 86B. When the protective circuit 78 determines that the battery module 71 satisfies the above-described predetermined condition, the protective circuit 78 can cut off conduction between the protective circuit 78 and the energizing external terminal 79. By cutting off the conduction between the protective circuit 78 and the energizing external terminal 79, the output of the current from the battery module 71 to the outside and the input of the current to the battery module 71 are stopped. This effectively prevents over-current or the like from continuously occurring in the battery module 71.

Instead of the adhesive tape 74, a heat shrinkable tape may be used for fixing the battery module 71. In this case, the protective sheet 88 is disposed on both sides of the battery module 71 along the long side direction, and the heat shrinkable tape is caused to circulate around the battery module 71. Therefore, the heat shrinkable tape is thermally shrunk to bind the battery module 71.

In addition, in the examples of FIGS. 11 and 12, the batteries 1 are connected in series to each other in the battery module 71, but the batteries may be connected in parallel to each other in the battery module. In addition, in the battery module, both the series connection in which the batteries are connected in series and the parallel connection in which the batteries are connected in parallel may be formed. In addition, plural of the battery pack may be formed, and the battery modules of the battery packs may be electrically connected in series and/or in parallel.

Even when a large current is taken out, the battery module of the above-described battery pack has excellent charge-and-discharge cycle characteristics. Therefore, even when a large current is taken out from the battery module, the above-described battery pack is used for applications requiring excellent charge-and-discharge cycle characteristics of the battery module. Specifically, the battery pack is used as a power supply for an electronic device, a stationary power supply, and in-vehicle power supplies for various vehicles. An example of the electronic device is a digital camera. In particular, the above-described battery pack is preferably used as an in-vehicle power supply.

In addition, since the battery of the above-described embodiment and the like is used for the battery pack, a high voltage can be obtained even with unit battery. That is, a high voltage can be obtained in the battery pack even if the number of batteries connected in series is small in the battery module or the like. Therefore, a high voltage can be obtained by using the battery of the above-described embodiment and the like for the battery pack, without increasing the size of the battery pack. Therefore, it is possible to obtain a high voltage while the energy density of the battery pack is maintained high.

[Vehicle]

Next, a vehicle, on which the above-described battery pack is installed, will be described. In the vehicle, the above-described battery pack recovers, for example, regenerative energy of the power of the vehicle. Examples of the vehicle, on which the battery pack is installed, include two-wheeled to four-wheeled hybrid electric automobiles, two-wheeled to four-wheeled electric automobiles, electrically assisted bicycles, and railway cars.

The installation position of the battery pack in the vehicle is not particularly limited. For example, when the battery pack is installed on the automobile, the battery pack can be installed in the engine compartment of the vehicle, in the rear sections of the automobile body, or under a seat. A plurality of battery packs may be installed in the vehicle. In such a case, the battery packs may be electrically connected in series, connected in parallel, or connected in a combination of in series connection and in parallel connection.

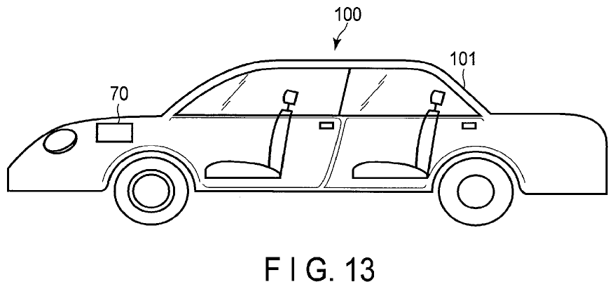

FIG. 13 is schematically showing an example of a vehicle on which the battery pack is installed. A vehicle 100 includes a vehicle body 101 and the above-described battery pack 70. In the example shown in FIG. 13, the vehicle 100 is a four-wheeled automobile.

This vehicle 100 may have plural battery packs 70 installed. In such a case, the battery packs 70 may be connected in series, connected in parallel, or connected in a combination of in-series connection and in-parallel connection.

In one example of FIG. 13, the battery pack 70 is installed in an engine compartment located at the front of the vehicle body 101. As mentioned above, for example, the battery pack 70 may be alternatively installed in rear sections of the vehicle body 101, or under a seat. The battery pack 70 may be used as a power source of the vehicle 100. The battery pack 70 can also recover regenerative energy of motive force of the vehicle 100.

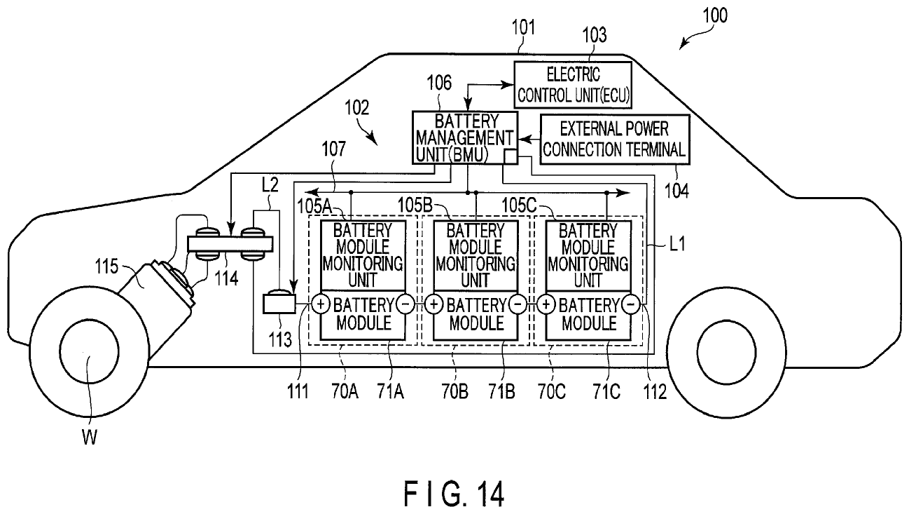

FIG. 14 schematically shows an example of a control system related to an electric system in a vehicle. A vehicle 100, shown in FIG. 14, is an electric automobile. The vehicle 100, shown in FIG. 14, includes a vehicle body 101, a vehicle power source 102, a vehicle ECU (electric control unit) 103, which is a master controller of the vehicle power source 102, an external terminal (an external power connection terminal) 104, an inverter 114, and a drive motor 115.

The vehicle 100 includes the vehicle power source 102, for example, in the engine compartment, in the rear sections of the automobile body, or under a seat. In FIG. 14, the position of the vehicle power source 102 installed in the vehicle 100 is schematically shown.

The vehicle power source 102 includes plural (three in the example of FIG. 14) battery packs 70A, 70B and 70C, a battery management unit (BMU) 106, and a communication bus 107. The three battery packs 70A, 70B and 70C are electrically connected in series. The battery pack 70A includes a battery module 71A and a battery module monitoring unit 105A (e.g., a VTM: voltage temperature monitoring). The battery pack 70B includes a battery module 71B, and a battery module monitoring unit 105B. The battery pack 70C includes a battery module 71C, and a battery module monitoring unit 105C. The battery packs 70A to 70C are the same battery pack as the above-described battery pack 70, and the battery modules 71A to 71C are the same battery module as the above-described battery module 71. The battery modules 71A, 71B and 71C can each be independently removed, and may be exchanged by a different battery pack 70.

Each of the battery modules 71A to 71C includes plural of battery (1) of the above-described embodiment and the like, and the batteries (1) are connected in series to each of the battery modules 71A to 71C. The battery modules 71A to 71C each perform charging and discharging via a positive electrode terminal 111 and a negative electrode terminal 112.

In order to collect information concerning security of the vehicle power source 102, the battery management unit 106 performs communication with the battery module monitoring units 105A to 105C and collects information such as voltages or temperatures of the single-batteries (1) included in the battery modules 71A to 71C included in the vehicle power source 102. The communication bus 107 is connected between the battery management unit 106 and the battery module monitoring units 105A to 105C. The communication bus 107 is configured so that multiple nodes (i.e., the battery management unit 106 and one or more battery module monitoring units 105A to 105C) share a set of communication lines. The communication bus 107 is, for example, a communication bus configured based on CAN (Control Area Network) standard.

The battery module monitoring units 105A to 105C measure a voltage and a temperature of each single-battery (1) in the battery modules 71A to 71C based on commands from the battery management unit 106. It is possible, however, to measure the temperatures only at several points per battery module (71A, 71B or 71C), and the temperatures of all of the single-batteries (1) need not be measured.

The vehicle power source 102 may also have an electromagnetic contactor (for example, a switch unit 113 shown in FIG. 14) for switching connection between the positive electrode terminal 111 and the negative electrode terminal 112. The switch unit 113 includes a precharge switch (not shown), which is turned on when the battery modules 71A to 71C are charged, and a main switch (not shown), which is turned on when battery output is supplied to a load. The precharge switch and the main switch include a relay circuit (not shown), which is turned on or off based on a signal provided to a coil disposed near the switch elements.

The inverter 114 converts an inputted direct current voltage to a three-phase alternate current (AC) high voltage for driving a motor. Three-phase output terminal(s) of the inverter 114 is (are) connected to each three-phase input terminal of the drive motor 115. The inverter 114 controls an output voltage based on control signals from the battery management unit 106 or the vehicle ECU 103, which controls the entire operation of the vehicle.

The drive motor 115 is rotated by electric power supplied from the inverter 114. The rotation is transferred to an axle and driving wheels W via a differential gear unit, for example.

The vehicle 100 also includes a regenerative brake mechanism (regenerator) which is not shown in figures. The regenerative brake mechanism rotates the drive motor 115 when the vehicle 100 is braked, and converts kinetic energy into regenerative energy, as electric energy. The regenerative energy, recovered in the regenerative brake mechanism, is inputted into the inverter 114 and converted to direct current. The direct current is inputted into the vehicle power source 102.

One terminal of a connecting line L1 is connected via a current detector (not shown) in the battery management unit 106 to the negative electrode terminal 112 of the vehicle power source 102. The other terminal of the connecting line L1 is connected to a negative electrode input terminal of the inverter 114.

One terminal of a connecting line L2 is connected via the switch unit 113 to the positive electrode terminal 111 of the vehicle power source 102. The other terminal of the connecting line L2 is connected to a positive electrode input terminal of the inverter 114. The external terminal 104 is connected to the battery management unit 106. The external terminal 104 is able to connect, for example, to an external power source.

The vehicle ECU 103 cooperatively controls the battery management unit 106 together with other units in response to inputs operated by a driver or the like, thereby performing the management of the whole vehicle 100. Data concerning the security of the vehicle power source 102, such as a remaining capacity of the vehicle power source 102, are transferred between the battery management unit 106 and the vehicle ECU 103 via communication lines.

The above-described battery pack is installed in the vehicle. As described above, a high voltage can be obtained without increasing the size of the battery pack. Therefore, in the vehicle, a high voltage can be obtained from the vehicle electric power supply, without increasing the vehicle electric power supply including the battery pack.

[Verification Related to Embodiment]

In addition, the verification related to the above-described embodiment was performed. The performed verification will be described below. In the verification, the batteries of Examples 1 to 4 and Comparative Examples 1 to 5 were produced. Then, the batteries of Examples 1 to 4 and Comparative Examples 1 to 5 were tested. The test conditions and test results of Examples 1 to 4 and Comparative Examples 1 to 5 will be described below with reference to Table 1.

TABLE 1

| | Number of series | Presence or | | Number of | Discharge capacity |
|---|---|---|---|---|---|
| | of electrode | absence of sheet | | defective | retention ratio η |
| | groups | member | Electrolyte | products | (%) |
| Example 1 | 2 | Present | Gel | 0 | 85 |
| Example 2 | 2 | Present | Liquid | 0 | 90 |
| Example 3 | 3 | Present | Gel | 0 | 85 |
| Example 4 | 3 | Present | Liquid | 0 | 90 |
| Comparative | 2 | Absent | Gel | 3 | 85 |
| Example 1 | | | | | |
| Comparative | 2 | Absent | Liquid | 10 | — |
| Example 2 | | | | | |
| Comparative | 3 | Absent | Gel | 4 | 85 |
| Example 3 | | | | | |
| Comparative | 3 | Absent | Liquid | 10 | — |
| Example 4 | | | | | |
| Comparative | 2 | Absent | Solid | 0 | 10 |
| Example 5 | | | | | |

### Example 1

In Example 1, as in the first embodiment (see FIG. 2 and the like), a battery in which two electrode groups were housed inside a container member was formed. Then, a sheet member was disposed between the two electrode groups, and the two electrode groups were isolated from each other by the sheet member. The sheet member used a laminated sheet. In the laminate sheet, as in the first embodiment, insulating layers were laminated on both surfaces of a metal layer. In the laminate sheet, the metal layer was made of aluminum, and the insulating layer was made of polypropylene. In addition, a laminated film was used as the container member. In the laminated film, the metal layer was made of aluminum, and the insulating layer was made of polypropylene.

In addition, in the battery, as in the first embodiment, the insulating layer of the sheet member was fused to a resin layer of the container member to form a sealing portion. Then, the interior of the container member was airtightly sealed to the exterior by the sealing portion, and the sheet member was firmly attached to the container member. In addition, as in the first embodiment, two opening holes were formed in the sheet member. The negative electrode current collecting tab of one of the two electrode groups was electrically connected to the metal layer of the sheet member at one of the opening holes, and the positive electrode current collecting tab of the other of the two electrode groups was electrically connected to the metal layer of the sheet member at the other of the opening holes. Therefore, as in the first embodiment, two electrode groups were connected in series to form a battery in which the number of series of electrode groups was two.

In addition, a nonaqueous electrolyte was held (impregnated) in each of the two electrode groups inside the container member. As the nonaqueous electrolyte, a gel nonaqueous electrolyte was used. In the preparation of the gel nonaqueous electrolyte, 1 M LiPF₆ serving as an electrolyte was dissolved in a mixed solvent containing polypropylene carbonate and diethyl carbonate (volume ratio of 1:1). Then, by mixing polyacrylonitrile into a solution in which LiPF₆ was dissolved, it was gelled to prepare a gel nonaqueous electrolyte.

In addition, in each of the electrode groups, the positive electrode current collector was formed of aluminum to a thickness of 15 μm and the negative electrode current collector was formed of aluminum to a thickness of 15 μm. In addition, in a positive electrode mixture layer disposed on the positive electrode current collector, lithium cobalt oxide was used as the positive electrode active material. In a negative electrode mixture layer disposed on the negative electrode current collector, spinel type lithium titanate was used as the negative electrode active material.

### Example 2

In Example 2, as a nonaqueous electrolyte, a nonaqueous electrolytic solution was used instead of the gel nonaqueous electrolyte. The nonaqueous electrolytic solution was prepared by dissolving 1 M LiPF₆ serving as an electrolyte in a mixed solvent containing polypropylene carbonate and diethyl carbonate (volume ratio of 1:1). A battery was formed in the same manner as in Example 1, except for the above-described matter.

### Example 3

In Example 3, as in the second modification of the first embodiment (see FIG. 8), three electrode groups were housed inside the container member. Then, three electrode groups were isolated from each other by two sheet members. For each of the two sheet members, the same laminated sheet as in Example 1 was used. Then, as in the second modification of the first embodiment, the three electrode groups were connected in series via a metal layer of the sheet member (laminated sheet). Therefore, a battery in which the number of series was three was formed.

In addition, in the battery, as in the second modification of the first embodiment, an insulating layer of each of the sheet members was fused to one of the insulating layer of the other sheet member and a resin layer of the container member to form a sealing portion. Then, the interior of the container member was airtightly sealed to the exterior by the sealing portion, and two sheet members were firmly attached to the container member. A battery was formed in the same manner as in Example 1, except for the above-described matter.

### Example 4

In Example 4, as a nonaqueous electrolyte, a nonaqueous electrolytic solution was used instead of the gel nonaqueous electrolyte. The nonaqueous electrolytic solution was prepared by dissolving 1 M LiPF₆ serving as an electrolyte in a mixed solvent containing polypropylene carbonate and diethyl carbonate (volume ratio of 1:1). A battery was formed in the same manner as in Example 3, except for the above-described matter.

### Comparative Example 1

In Comparative Example 1, no sheet member was used and two electrode groups were not isolated from each other in a container member. A battery was formed in the same manner as in Example 1, except for the above-described matter.

### Comparative Example 2

In Comparative Example 2, no sheet member was used and two electrode groups were not isolated from each other in a container member. A battery was formed in the same manner as in Example 2, except for the above-described matter.

### Comparative Example 3

In Comparative Example 3, no sheet member was used and three electrode groups were not isolated from each other in a container member. A battery was formed in the same manner as in Example 3, except for the above-described matter.

### Comparative Example 4

In Comparative Example 4, no sheet member was used and three electrode groups were not isolated from each other in a container member. A battery was formed in the same manner as in Example 4, except for the above-described matter.

### Comparative Example 5

In Example 5, as a nonaqueous electrolyte, a solid electrolyte solution was used instead of the gel nonaqueous electrolyte. As the solid electrolyte, garnet type LLZ (Li₇La₃Zr₂O₁₂) was used.

In addition, no sheet member was used and two electrode groups were not isolated from each other in a container member. A battery was formed in the same manner as in Example 1, except for the above-described matter.

<Test Contents>

In the test, ten batteries were produced for each of Examples 1 to 4 and Comparative Examples 1 to 5. Then, each of the produced batteries was tested.

In the test, each of the batteries was charged at a charge rate of 1 C up to 2.4×(number of series of electrode groups) V. After the charge was completed, each of the batteries was stored for 168 hours under an environment of 60° C., and a storage test was performed. Then, after storage for 168 hours, a voltage was measured for each of the batteries. Then, for a battery whose measured voltage was less than 2.3×(number of series of electrode groups) V, the battery was regarded as a defective product. In the tests, the number of defective products among the ten batteries was verified for each of Examples 1 to 4 and Comparative Examples 1 to 5.

In addition, in the tests, the following verification was also performed for each of the produced batteries. In the verification, each of the batteries was charged at a charge rate of 1 C up to 2.8×(number of series of electrode groups) V. Then, after the charge was completed, each of the batteries was discharged at a discharge rate of 1 C up to 1.5×(number of series of electrode groups) V. At this time, a discharge capacity Q1 in a discharge at a discharge rate of 1 C was measured. After the discharge was completed, each of the batteries was recharged at a charge rate of 1 C up to 2.8×(number of series of electrode groups) V. Then, after the charge was completed, each of the batteries was discharged at a discharge rate of 5 C up to 1.5×(number of series of electrode groups) V. At this time, a discharge capacity Q2 in a discharge at a discharge rate of 5 C was measured. For each of the batteries, a discharge capacity retention ratio η was calculated as a ratio of the discharge capacity Q2 at the discharge rate of 5 C to the discharge capacity Q1 at the discharge rate of 1 C. The discharge capacity retention ratio η was calculated by using Formula (1) below.

η(%)=(Q2/Q1)×100 (1)

<Test Result and Consideration>

Table 1 shows the number of defective products after the storage test and the calculated discharge capacity retention ratio η. As shown in Table 1, in each of Comparative Examples 1 to 4, at least three of the ten batteries were defective after the storage test. In contrast, in each of Examples 1 to 4, there were no defective products among the ten batteries after the storage test.

Therefore, it has been proven that, in the configuration in which the sheet member of the above-described embodiment and the like was provided, a short circuit between the electrode groups via the electrolyte was prevented in the container member. Therefore, even in the battery in which the electrolytic solution was used as the nonaqueous electrolyte, it was proven that a short circuit between the electrode groups via the electrolytic solution was prevented by providing the sheet member according to the above-described embodiment or the like. Even in the battery in which the gel electrolyte was used as the nonaqueous electrolyte, it was proven that a short circuit between the electrode groups via the softened gel electrolyte was prevented by providing the sheet member according to the above-described embodiment or the like.

In addition, in Comparative Example 5 as well, there were no defective products among the ten batteries after the storage test. Therefore, it was confirmed that a short circuit between the electrode groups via the electrolyte was prevented by using the solid electrolyte as the nonaqueous electrolyte, without providing the sheet member of the above-described embodiment or the like.

However, as described above, the ion conductivity of the solid electrolyte is lower than that of the nonaqueous electrolytic solution and the gel nonaqueous electrolyte. Therefore, in Comparative Example 5 in which the solid electrolyte was used as the nonaqueous electrolyte, the discharge capacity Q2 at the discharge rate of 5 C significantly decreased as compared with the discharge capacity Q1 at the discharge rate 1 C, and the discharge capacity retention ratio η was low. On the other hand, in each of Examples 1 to 4, since the nonaqueous electrolytic solution or the gel nonaqueous electrolyte was used as the nonaqueous electrolyte, the discharge capacity Q2 at the discharge rate of 5 C did not greatly decreased as compared with the discharge capacity Q1 at the discharge rate of 1 C, and the discharge capacity retention ratio η was high.

Therefore, it was proven that since the electrolytic solution or the gel electrolyte was used as the nonaqueous electrolyte, the discharge capacity does not greatly decrease even during the discharge with a large current. Therefore, it was proven that since the electrolytic solution or the gel electrolyte was used as the nonaqueous electrolyte, the high output density of the battery was secured.

In each of Comparative Examples 2 and 4, in the verification of calculating the discharge capacity retention ratio η, none of the ten batteries was charged up to 2.8×(number of series of electrode groups) V at the first charge. Therefore, in each of Comparative Examples 2 and 4, it was impossible to calculate the discharge capacity retention ratio r.

According to the battery of at least one embodiment or Example, the electrode groups are arranged inside the container member, and the sheet member serves as the partition wall that isolates adjacent electrode groups from each other. In the sheet member, the metal layer forms the electric path, the electric path electrically connects the adjacent electrode groups. In the sheet member, the insulating layers are laminated on both sides of the metal layer in the arranging direction of the adjacent electrode groups. Therefore, in the configuration in which the plurality of the electrode groups are provided in the container member, it is possible to provide the battery in which the short circuit between the electrode groups due to ionic conduction is effectively prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery comprising:
a container member;
electrode groups housed inside the container member, each of the electrode groups comprising a positive electrode and a negative electrode; and
at least one sheet member which serves as partition walls separating adjacent electrode groups, the adjacent electrode groups being adjacent to each other in the interior of the container member, wherein
the at least one sheet member comprises:
a metal layer which forms an electric path, the electric path electrically connecting the adjacent electrode groups; and
an insulating layer which is made of a material having electrical insulation properties, and which is laminated on both sides of the metal layer in an arranging direction of the adjacent electrode groups.

2. The battery according to claim 1, wherein the insulating layer of the sheet member is made of a resin having thermal adhesiveness.

3. The battery according to claim 2, wherein the resin forming the insulating layer includes one or more selected from the group consisting of polypropylene and polyethylene.

4. The battery according to claim 1, wherein
the metal layer of the sheet member includes a first surface facing one side in the arranging direction, and a second surface facing a side opposite to the side toward which the first surface faces in the arranging direction,
the insulating layer of the sheet member includes a first insulating layer laminated on the first surface of the metal layer, and a second insulating layer laminated on the second surface of the metal layer,
a first opening hole exposing the first surface of the metal layer is formed in the first insulating layer of the sheet member, and a second opening hole exposing the second surface of the metal layer is formed in the second insulating layer, and
one of the electrode groups, which are objects to be isolated by the sheet member, is electrically connected to the metal layer through the first opening hole, and the other of the electrode groups is electrically connected to the metal layer through the second opening hole.

5. The battery according to claim 4, wherein
the first insulating layer of the sheet member is laminated over an entire region of the first surface, except for the first opening hole, and
the second insulating layer of the sheet member is laminated over an entire region of the second surface, except for the second opening hole.

6. The battery according to claim 4, wherein
the first insulating layer of the sheet member includes a first edge surface surrounding the first opening hole, and the second insulating layer includes a second edge surface surrounding the second opening hole, and
the sheet member includes an adhesive layer on at least one of the first edge surface of the first insulating layer and the second edge surface of the second insulating layer.

7. The battery according to claim 4, wherein
the first insulating layer of the sheet member includes a first edge surface surrounding the first opening hole, and the second insulating layer includes a second edge surface surrounding the second opening hole, and
in the sheet member, at least one of
the first edge surface is formed in a tapered shape and a cross-sectional area of the first opening hole decreases as approaching the metal layer, and
the second edge surface is formed in a tapered shape, and a cross-sectional area of the second opening hole decreases as approaching the metal layer.

8. The battery according to claim 1, further comprising an electrolytic solution or a gel electrolyte held as an electrolyte in each of the electrode groups.

9. The battery according to claim 1, wherein the metal layer of the sheet member includes aluminum.

10. The battery according to claim 1, wherein at least one of the electrode groups includes a titanium-containing oxide as a negative electrode active material.

11. The battery according to claim 1, wherein
the container member includes a laminated film,
the laminated film includes first and second resin layers, and a film metal layer interposed between the first and second resin layers, and
the second resin layer forms an inner surface of the container member.

12. The battery according to claim 11, wherein the insulating layer of the sheet member is made of the same material as the second resin layer of the container member.

13. The battery according to claim 11, wherein the insulating layer of the sheet member and the second resin layer of the container member have thermal adhesiveness.

14. A battery pack comprising the battery according to claim 1.

15. The battery pack according to claim 14, further comprising:
an external terminal electrically connected to the battery; and
a protective circuit.

16. The battery pack according to claim 14, comprising
plural of the battery, wherein
the batteries are electrically connected in series, electrically connected in parallel, or electrically connected in a combination of in series connection and in parallel connection.

17. A vehicle comprising the battery pack according to claim 14.

18. The vehicle according to claim 17, further comprising a mechanism which converts kinetic energy of the vehicle into regenerative energy.
